(19) United States
(12) Patent Application Publication
(10) Pub. No.: US 2021/0155839 A1
(43) Pub. Date: May 27, 2021

(54) COMPOSITIONS BASED ON 1,1,2-TRIFLUOROETHYLENE AND CARBON DIOXIDE

(71) Applicant: ARKEMA FRANCE, Colombes (FR)

(72) Inventor: Wissam RACHED, Colombes (FR)

(73) Assignee: ARKEMA FRANCE, Colombes (FR)

(21) Appl. No.: 16/972,256

(22) PCT Filed: Jun. 5, 2019
(86) PCT No.: PCT/FR2019/051341

§ 371 Date: Dec. 4, 2020

(30) Foreign Application Priority Data
Jun. 5, 2018 (FR) 1854869

(51) Int. Cl. C09K 5/04

(52) U.S. Cl. CPC C09K 5/045; C09K 2205/126; C09K 2205/40; C09K 2205/106; C09K 2205/122

(57) ABSTRACT

The invention relates to a composition containing 1,1,2-trifluoroethylene and carbon dioxide, and possibly additional compounds, as well as to the use thereof, particularly as a refrigerant for replacing the conventional fluid R-410A.

### FIELD OF THE INVENTION

The present invention relates to compositions of 1,1,2-trifluoroethylene (HFO-1123) and carbon dioxide (CO₂), and to the use thereof as heat transfer fluids, in particular for replacing R-410A.

### TECHNICAL BACKGROUND

R-410A is a heat transfer fluid consisting of 50% by weight of difluoromethane (HFC-32) and 50% by weight of pentafluoroethane (HFC-125). It has a low boiling point at −48.5° C., a high energy efficiency, it is non-flammable and non-toxic. It is used in particular for stationary air conditioning. However, this heat transfer fluid has a high global warming potential (GWP). It is therefore desirable to replace it.

Document US 2014/0070132 describes various heat transfer fluids comprising 1,1,2-trifluoroethylene (HFO-1123).

Documents US 2016/0347981 and US 2016/0333243 describe various heat transfer fluids comprising HFO-1123, in particular for replacing R-410A.

There is a need to design new heat transfer fluids, in particular to replace conventional heat transfer fluids such as R-410A.

There is in particular a need for low GWP heat transfer fluids which are harmless to the ozone layer, which have good thermodynamic properties for heat transfer, and which are preferably non-flammable and non-toxic.

### SUMMARY OF THE INVENTION

The invention relates firstly to a composition comprising 1,1,2-trifluoroethylene and carbon dioxide.

In embodiments, the composition comprises one or more additional compounds chosen from ammonia and optionally halogenated alkanes and alkenes, and preferably from hydrofluoroolefins, hydrochlorofluoroolefins and saturated hydrofluorocarbons.

In embodiments, the composition comprises one or more additional compounds chosen from 1,1,1,2-tetrafluoroethane, pentafluoroethane, difluoromethane, 2,3,3,3-tetrafluoropropene, 1,3,3,3-tetrafluoropropene, ammonia, 1,1,1,2,3,3,3-heptafluoropropane, propane, propylene, 1,1,1-trifluoroethane, 1-chloro-3,3,3-trifluoropropene, 1,1,1,4,4,4-hexafluorobut-2-ene, 1,1,1,3,3-pentafluoropropane, 1,1,2,2-tetrafluoroethane, 1,1-difluoroethane and combinations thereof; and preferably from 1,1,1,2-tetrafluoroethane, pentafluoroethane, difluoromethane, 2,3,3,3-tetrafluoropropene, 1,3,3,3-tetrafluoropropene and combinations thereof.

In embodiments, the composition consists essentially of:
1,1,2-trifluoroethylene and carbon dioxide; or
1,1,2-trifluoroethylene, carbon dioxide and 1,1,1,2-tetrafluoroethane; or
1,1,2-trifluoroethylene, carbon dioxide and pentafluoroethane; or
1,1,2-trifluoroethylene, carbon dioxide and difluoromethane; or
1,1,2-trifluoroethylene, carbon dioxide and 2,3,3,3-tetrafluoropropene; or
1,1,2-trifluoroethylene, carbon dioxide and 1,3,3,3-tetrafluoropropene; or
1,1,2-trifluoroethylene, carbon dioxide, 1,1,1,2-tetrafluoroethane and pentafluoroethane; or
1,1,2-trifluoroethylene, carbon dioxide, 1,1,1,2-tetrafluoroethane and difluoromethane; or
1,1,2-trifluoroethylene, carbon dioxide, 1,1,1,2-tetrafluoroethane and 2,3,3,3-tetrafluoropropene; or
1,1,2-trifluoroethylene, carbon dioxide, 1,1,1,2-tetrafluoroethane and 1,3,3,3-tetrafluoropropene; or
1,1,2-trifluoroethylene, carbon dioxide, pentafluoroethane and difluoromethane; or
1,1,2-trifluoroethylene, carbon dioxide, pentafluoroethane and 2,3,3,3-tetrafluoropropene; or
1,1,2-trifluoroethylene, carbon dioxide, pentafluoroethane and 1,3,3,3-tetrafluoropropene; or
1,1,2-trifluoroethylene, carbon dioxide, difluoromethane and 2,3,3,3-tetrafluoropropene; or
1,1,2-trifluoroethylene, carbon dioxide, difluoromethane and 1,3,3,3-tetrafluoropropene; or
1,1,2-trifluoroethylene, carbon dioxide, 2,3,3,3-tetrafluoropropene and 1,3,3,3-tetrafluoropropene; or
1,1,2-trifluoroethylene, carbon dioxide, 1,1,1,2-tetrafluoroethane, difluoromethane and pentafluoroethane; or
1,1,2-trifluoroethylene, carbon dioxide, 1,1,1,2-tetrafluoroethane, difluoromethane and 2,3,3,3-tetrafluoropropene; or
1,1,2-trifluoroethylene, carbon dioxide, 1,1,1,2-tetrafluoroethane, difluoromethane and 1,3,3,3-tetrafluoropropene; or
1,1,2-trifluoroethylene, carbon dioxide, 1,1,1,2-tetrafluoroethane, pentafluoroethane and 2,3,3,3-tetrafluoropropene; or
1,1,2-trifluoroethylene, carbon dioxide, 1,1,1,2-tetrafluoroethane, pentafluoroethane and 1,3,3,3-tetrafluoropropene; or
1,1,2-trifluoroethylene, carbon dioxide, 1,1,1,2-tetrafluoroethane, 2,3,3,3-tetrafluoropropene and 1,3,3,3-tetrafluoropropene; or
1,1,2-trifluoroethylene, carbon dioxide, 1,1,1,2-tetrafluoroethane, difluoromethane, pentafluoroethane and 2,3,3,3-tetrafluoropropene; or
1,1,2-trifluoroethylene, carbon dioxide, 1,1,1,2-tetrafluoroethane, difluoromethane, pentafluoroethane and 1,3,3,3-tetrafluoropropene; or
1,1,2-trifluoroethylene, carbon dioxide, 1,1,1,2-tetrafluoroethane, difluoromethane, pentafluoroethane, 2,3,3,3-tetrafluoropropene and 1,3, 3,3-tetrafluoropropene.

In embodiments, the proportion of 1,1,2-trifluoroethylene is from 5 to 80% by weight, preferably 10 to 70% by weight, more preferably 15 to 60% by weight.

In embodiments, the total proportion of carbon dioxide and where appropriate of 1,1,1,2-tetrafluoroethane and/or of pentafluoroethane is at least 15% by weight, preferably at least 30% by weight, and more preferably at least 35% by weight.

In embodiments, the composition is chosen from mixtures consisting essentially of:
from 40 to 70% of 1,1,2-trifluoroethylene, from 5 to 30% of carbon dioxide and from 5 to 30% of pentafluoroethane (by weight);
from 55 to 70% of 1,1,2-trifluoroethylene, from 5 to 30% of carbon dioxide and from 5 to 35% of 1,1,1,2-tetrafluoroethane (by weight);
from 5 to 70% of 1,1,2-trifluoroethylene, from 5 to 35% of carbon dioxide and from 5 to 60% of difluoromethane (by weight);
from 5 to 55% of 1,1,2-trifluoroethylene, from 5 to 35% of carbon dioxide, from 5 to 25% of pentafluoroethane and from 5 to 60% of difluoromethane (by weight);
from 5 to 65% of 1,1,2-trifluoroethylene, from 5 to 30% of carbon dioxide, from 5 to 30% of pentafluoroethane, from 5 to 10% of 1,1,1,2-tetrafluoroethane and from 5 to 60% of difluoromethane (by weight).

In embodiments, the composition is non-flammable.

In embodiments, the composition has a GWP of less than or equal to 1000, and preferably less than or equal to 150.

The invention also relates to the use of the composition described above, as a heat transfer fluid.

In embodiments, said use is for replacing R-410A, preferably in stationary air conditioning.

The invention also relates to a heat transfer composition, comprising the composition described above as a heat transfer fluid, and one or more additives.

In embodiments, the additives are chosen from lubricants, nanoparticles, stabilizers, surfactants, tracer agents, fluorescent agents, odorants, solubilizers and combinations thereof.

The invention also relates to a heat transfer apparatus comprising a vapor-compression circuit containing a composition as described above as a heat transfer fluid or containing a heat transfer composition as described above.

In embodiments, the apparatus is chosen from mobile or stationary apparatuses for heating by heat pump, air conditioning, and in particular motor vehicle air conditioning or centralized stationary air conditioning, refrigeration, freezing and Rankine cycles, and preferably is an air conditioning apparatus.

The invention also relates to a process for heating or cooling a fluid or a body by means of a vapor-compression circuit containing a heat transfer fluid, said process successively comprising evaporation of the heat transfer fluid, compression of the heat transfer fluid, condensation of the heat transfer fluid and expansion of the heat transfer fluid, wherein the heat transfer fluid is a composition as described above.

The invention also relates to a process of the reduction of environmental impact of a heat transfer apparatus comprising a vapor-compression circuit containing an initial heat transfer fluid, said process comprising a step of replacing the initial heat transfer fluid in the vapor-compression circuit with a final transfer fluid, the final transfer fluid having a lower GWP than the initial heat transfer fluid, wherein the final heat transfer fluid is a composition as described above.

In some embodiments, the initial heat transfer fluid is R-410A.

The present invention meets the need expressed in the prior art. More particularly, it provides new heat transfer fluids which are very suitable for replacing conventional heat transfer fluids and primarily R-410A.

In particular, the invention provides heat transfer fluids which are harmless to the ozone layer (i.e. with low or zero ozone depletion potential or ODP), which have a low GWP, which exhibit good thermodynamic properties for heat transfer, and which are preferably non-flammable and non-toxic.

This is accomplished by combining HFO-1123 with CO₂ (or R-744), and optionally with one or more other heat transfer compounds.

### DESCRIPTION OF EMBODIMENTS OF THE INVENTION

The invention is now described in greater detail and in a nonlimiting manner in the description that follows.

Unless indicated otherwise, throughout the application the indicated proportions of compounds are given as percentages by weight.

According to the present application, the global warming potential (GWP) is defined with respect to carbon dioxide and with respect to a period of 100 years, according to the method indicated in “The scientific assessment of ozone depletion, 2002, a report of the World Meteorological Association's Global Ozone Research and Monitoring Project”.

The term “heat transfer compound” or, respectively, “heat transfer fluid” (or refrigerant) refers to a compound or, respectively, a fluid, which is capable of absorbing heat by evaporating at low temperature and low pressure and of discharging heat by condensing at high temperature and high pressure, in a vapor-compression circuit. Generally, a heat transfer fluid may comprise just one, two, three or more than three heat transfer compounds.

The term “heat transfer composition” refers to a composition comprising a heat transfer fluid and optionally one or more additives which are not heat transfer compounds for the application envisaged.

### General Presentation of the Heat Transfer Composition Formulations

In the heat transfer composition of the invention, the proportion by weight of heat transfer fluid may especially represent from 1 to 5% of the composition; or from 5 to 10% of the composition; or from 10 to 15% of the composition; or from 15 to 20% of the composition; or from 20 to 25% of the composition; or from 25 to 30% of the composition; or from 30 to 35% of the composition; or from 35 to 40% of the composition; or from 40 to 45% of the composition; or from 45 to 50% of the composition; or from 50 to 55% of the composition; or from 55 to 60% of the composition; or from 60 to 65% of the composition; or from 65 to 70% of the composition; or from 70 to 75% of the composition; or from 75 to 80% of the composition; or from 80 to 85% of the composition; or from 85 to 90% of the composition; or from 90 to 95% of the composition; or from 95 to 99% of the composition.

In the present description, when a number of possible ranges are envisaged, the ranges resulting from the combination thereof are also covered: for example, the proportion by weight of heat transfer fluid in the heat transfer composition may be from 50 to 55%, and from 55 to 60%, i.e. from 50 to 60%, etc.

Preferably, the heat transfer composition of the invention comprises at least 50% by weight of heat transfer fluid, and in particular from 50% to 95% by weight.

In the heat transfer composition, the proportion by weight of lubricant(s) may especially represent from 1 to 5% of the composition; or from 5 to 10% of the composition; or from 10 to 15% of the composition; or from 15 to 20% of the composition; or from 20 to 25% of the composition; or from 25 to 30% of the composition; or from 30 to 35% of the composition; or from 35 to 40% of the composition; or from 40 to 45% of the composition; or from 45 to 50% of the composition; or from 50 to 55% of the composition; or from 55 to 60% of the composition; or from 60 to 65% of the composition; or from 65 to 70% of the composition; or from 70 to 75% of the composition; or from 75 to 80% of the composition; or from 80 to 85% of the composition; or from 85 to 90% of the composition; or from 90 to 95% of the composition; or from 95 to 99% of the composition.

The additives other than the lubricant(s) represent preferably from 0 to 30%, more preferably from 0 to 20%, more preferably from 0 to 10%, more preferably from 0 to 5%, and more preferably from 0 to 2% of each heat transfer composition, in proportions by weight.

### General Presentation of the Additives

The additives which may be present in the heat transfer composition of the invention may especially be chosen from lubricants, nanoparticles, stabilizers, surfactants, tracer agents, fluorescent agents, odorants and solubilizers.

By way of lubricants, use may in particular be made of oils of mineral origin, silicone oils, paraffins of natural origin, naphthenes, synthetic paraffins, alkylbenzenes, poly-alpha-olefins, polyalkylene glycols, polyol esters and/or polyvinyl ethers. Polyalkylene glycols and polyol esters are preferred.

The stabilizer(s), when they are present, preferably represent at most 5% by weight in the heat transfer composition. Mention may notably be made, among the stabilizers, of nitromethane, ascorbic acid, terephthalic acid, azoles, such as tolutriazole or benzotriazole, phenolic compounds, such as tocopherol, hydroquinone, (t-butyl)hydroquinone or 2,6-di(tert-butyl)-4-methylphenol, epoxides (alkyl, which is optionally fluorinated or perfluorinated, or alkenyl or aromatic), such as n-butyl glycidyl ether, hexanediol diglycidyl ether, allyl glycidyl ether or butylphenyl glycidyl ether, phosphites, phosphonates, thiols and lactones.

Propene, butenes, pentenes and hexenes can also be used as stabilizers. Butenes and pentenes are preferred. Pentenes are even more particularly preferred. These stabilizers can be straight-chain or branched-chain stabilizers and preferably branched-chain stabilizers. Preferably, they have a boiling point of less than or equal to 100° C., more preferably less than or equal to 75° C., and more particularly preferably less than or equal to 50° C. The term “boiling point” is understood to mean the boiling point at a pressure of 101.325 kPa, as determined according to standard NF EN 378-1 of April 2008. Also preferably, they have a solidification temperature of less than or equal to 0° C., preferably less than or equal to −25° C., and more particularly preferably less than or equal to −50° C.

The solidification temperature is determined according to Test no. 102: The term “melting point/melting range” (OECD guidelines for the testing of chemicals, Section 1, OECD publications, Paris, 1995, 20 available at the web address http://dx.doi.org/10.1787/9789264069534-fr).

Particular stabilizing compounds are notably 1-butene, cis-2-butene; trans-2-butene; 2-methyl-1-propene; 1-pentene; cis-2-pentene; trans-2-pentene; 2-methyl-1-butene; 2-methyl-2-butene; and 3-methyl-1-butene. Among the preferred compounds are in particular 2-methyl-2-butene (boiling point of approximately 39° C.) and 3-methyl-1-butene (boiling point of approximately 25° C.).

Nanoparticles which may be used include, especially, carbon nanoparticles, metal (copper, aluminum) oxides, TiO₂, Al₂O₃, MoS₂, etc.

As tracer agents (capable of being detected), mention may be made of deuterated or non-deuterated hydrofluorocarbons, deuterated hydrocarbons, perfluorocarbons, fluoroethers, brominated compounds, iodinated compounds, alcohols, aldehydes, ketones, nitrous oxide and combinations thereof. The tracer agent is different than the compounds making up the heat transfer fluid.

As solubilizers, mention may be made of hydrocarbons, dimethyl ether, polyoxyalkylene ethers, amides, ketones, nitriles, chlorocarbons, esters, lactones, aryl ethers, fluoroethers and 1,1,1-trifluoroalkanes. The solubilizer is different than the heat transfer compound or compounds making up the heat transfer fluid.

Mention may be made, as fluorescent agents, of naphthalimides, perylenes, coumarins, anthracenes, phenanthracenes, xanthenes, thioxanthenes, naphthoxanthenes, fluoresceins and derivatives and combinations thereof.

As odorants, mention may be made of alkyl acrylates, allyl acrylates, acrylic acids, acryl esters, alkyl ethers, alkyl esters, alkynes, aldehydes, thiols, thioethers, disulfides, allyl isothiocyanates, alkanoic acids, amines, norbornenes, norbornene derivatives, cyclohexene, aromatic heterocyclic compounds, ascaridole, o-methoxy(methyl)phenol and combinations thereof.

### General Presentation of the Heat Transfer Process

The heat transfer process of the invention is implemented in a heat transfer apparatus. The heat transfer apparatus preferably comprises a vapor-compression system. The system contains the heat transfer composition (including the heat transfer fluid), which provides heat transfer.

The heat transfer process may be a process for heating or cooling a fluid or a body.

In some embodiments, the vapor-compression system is:
an air conditioning system; or
a refrigeration system; or
a freezing system; or
a heat pump system.

The apparatus may be mobile or stationary.

The heat transfer process may therefore be a stationary air conditioning process (in dwellings or in industrial or commercial premises), or a mobile air conditioning process, especially a motor vehicle air conditioning process, a stationary refrigeration or mobile refrigeration process (for example, refrigerated transport), or a stationary freezing or deep-freezing process, or a mobile freezing or deep-freezing process (for example, refrigerated transport), or a stationary heating process or mobile heating process (automotive, for example).

The heat transfer process advantageously comprises the following steps, which are implemented cyclically:
evaporating the refrigerant in an evaporator;
compressing the refrigerant in a compressor;
condensing the refrigerant in a condenser; and
expanding the refrigerant in an expansion module.

The refrigerant may be evaporated from a liquid phase or from a two-phase liquid/vapor phase.

The compressor may be hermetic, semihermetic or open. Hermetic compressors comprise a motor part and a compression part, which are contained within an undismantlable hermetic enclosure. Semihermetic compressors comprise a motor part and a compression part, which are assembled directly with one another. The coupling between the motor part and the compression part is accessible by detaching the two parts by dismantling. Open compressors comprise a motor part and a compression part which are separate. They may operate by belt drive or by direct coupling.

The compressor used may especially be a dynamic compressor, or a positive displacement compressor.

Dynamic compressors include axial compressors and centrifugal compressors, which may have one or more stages. Centrifugal mini-compressors may also be employed.

Positive displacement compressors include rotary compressors and reciprocating compressors.

Reciprocating compressors include diaphragm compressors and piston compressors.

Rotary compressors include screw compressors, lobe compressors, scroll (or spiral) compressors, liquid ring compressors, and blade compressors. Screw compressors may preferably be twin-screw or single-screw.

In the apparatus which is used, the compressor may be driven by an electric motor or by a gas turbine (fed, for example, by the exhaust gases of a vehicle, for mobile applications) or by gearing.

The evaporator and the condenser are heat exchangers. Use may be made of any type of heat exchanger in the invention, and especially cocurrent heat exchangers, or preferably countercurrent heat exchangers.

The term “countercurrent heat exchanger” refers to a heat exchanger in which heat is exchanged between a first fluid and a second fluid, the first fluid at the inlet of the exchanger exchanging heat with the second fluid at the outlet of the exchanger, and the first fluid at the outlet of the exchanger exchanging heat with the second fluid at the inlet of the exchanger.

For example, countercurrent heat exchangers include devices in which the flow of the first fluid and the flow of the second fluid are in opposite directions or virtually opposite directions. Exchangers operating in crosscurrent mode with a countercurrent tendency are also included among the countercurrent heat exchangers.

The apparatus may also optionally comprise at least one heat transfer fluid circuit used to transmit heat (with or without change of state) between the heat transfer composition circuit and the fluid or body to be heated or cooled.

The apparatus may also optionally comprise two (or more) vapor-compression circuits containing identical or distinct heat transfer compositions. For example, the vapor-compression circuits may be coupled to each other. In this case, at least one of these circuits contains the heat transfer fluid according to the invention, the other possibly containing, where appropriate, another heat transfer fluid.

In some embodiments, the refrigerant is superheated between evaporation and compression, that is to say it is brought to a temperature above the evaporation end temperature, between evaporation and compression.

The term “evaporation onset temperature” refers to the temperature of the refrigerant at the inlet of the evaporator.

The term “evaporation end temperature” refers to the temperature of the refrigerant on evaporation of the last drop of refrigerant in liquid form (saturated vapor temperature or dew point).

When the refrigerant is an azeotropic mixture, the evaporation onset temperature is equal to the evaporation end temperature. For zeotropic mixtures, the temperature glide at the evaporator is defined as being the difference between the evaporation end temperature and the evaporation onset temperature.

The heat transfer process according to the invention is preferably carried out with a temperature glide of less than or equal to 10° C., or less than or equal to 8° C., or less than or equal to 6° C., or less than or equal to 5° C., or less than or equal to 4° C., or less than or equal to 3° C., or less than or equal to 2° C., or less than or equal to 1° C.

The term “mean evaporation temperature” refers to the arithmetic mean between the evaporation onset temperature and the evaporation end temperature.

The term “superheating” (equivalent here to “superheating at the evaporator”) denotes the temperature differential between the maximum temperature attained by the refrigerant before compression (i.e., the maximum temperature attained by the refrigerant at the end of the superheating step) and the evaporation end temperature. This maximum temperature is generally the temperature of the refrigerant at the inlet of the compressor. It may correspond to the temperature of the refrigerant at the outlet of the evaporator. Alternatively, the refrigerant may be at least partially superheated between the evaporator and the compressor (by means, for example, of an internal exchanger). The superheating may be adjusted by appropriate regulation of the parameters of the apparatus, and especially by regulation of the expansion module.

In the process of the invention, superheating is preferably applied. The overheating can in particular be equal to from 1 to 2° C.; or from 2 to 3° C.; or from 3 to 4° C.; or from 4 to 5° C.; or from 5 to 7° C.; or from 7 to 10° C.; or from 10 to 15° C.; or from 15 to 20° C.; or from 20 to 25° C.; or from 25 to 30° C.; or from 30 to 50° C.

The expansion module may be a valve which is thermostatic and called a thermostatic expander or electronic having one or more orifices, or a pressostatic expander, which regulates the pressure. It may also be a capillary tube, in which the expansion of the fluid is obtained by the pressure drop in the tube. The expansion module may also be a turbine for producing mechanical work (which can be converted into electricity), or a turbine coupled directly or indirectly to the compressor.

The mean condensation temperature is defined as being the arithmetic mean between the condensation onset temperature (temperature of the refrigerant in the condenser on appearance of the first liquid drop of refrigerant, called the saturated vapor temperature or dew point) and the condensation end temperature (temperature of the refrigerant on condensation of the last bubble of refrigerant in gas form, called saturated liquid temperature or bubble point).

The term “subcooling” denotes the possible temperature differential (as absolute value) between the minimum temperature attained by the refrigerant before expansion and the condensation end temperature. This minimum temperature generally corresponds to the temperature of the refrigerant at the inlet of the expansion module. It may correspond to the temperature of the refrigerant at the outlet of the condenser. Alternatively, the refrigerant may be at least partially subcooled between the condenser and the expansion module (by means, for example, of an internal exchanger).

Preferably, in the process of the invention, a subcooling (strictly greater than 0° C.) is applied, preferably a subcooling of 1 to 40° C., a sub-cooling of 1 to 30° C., a subcooling of 1 to 15° C., more preferably of 2 to 12° C. and more preferably of 5 to 10° C.

The invention is particularly useful when the mean evaporation temperature is less than or equal to 10° C.; or less than or equal to 5° C.; or less than or equal to 0° C.; or less than or equal to −5° C.; or less than or equal to −10° C.

The invention is particularly useful, therefore, for the implementation of a low-temperature refrigeration process, or moderate-temperature cooling process, or moderate-temperature heating process.

In “low-temperature refrigeration” processes, the mean evaporation temperature is preferably from −45° C. to −15° C., especially from −40° C. to −20° C., more particularly preferably from −35° C. to −25° C. and for example around −30° C.; and the mean condensation temperature is preferably from 25° C. to 80° C., especially from 30° C. to 60° C., more particularly preferably from 35° C. to 55° C. and for example around 40° C. These processes include, especially, freezing and deep-freezing processes.

In “moderate-temperature cooling” processes, the mean evaporation temperature is preferably from −20° C. to 10° C., especially from −15° C. to 5° C., more particularly preferably from −10° C. to 0° C. and for example around −5° C.; and the mean condensation temperature is preferably from 25° C. to 80° C., especially from 30° C. to 60° C., more particularly preferably from 35° C. to 55° C. and for example around 50° C. These processes may especially be refrigeration or air conditioning processes.

In “moderate-temperature heating” processes, the mean evaporation temperature is preferably from −20° C. to 10° C., especially from −15° C. to 5° C., more particularly preferably from −10° C. to 0° C. and for example around −5° C.; and the mean condensation temperature is preferably from 25° C. to 80° C., especially from 30° C. to 60° C., more particularly preferably from 35° C. to 55° C. and for example around 50° C.

In certain embodiments, the heat transfer apparatus was originally designed to operate with another heat transfer fluid, called the initial heat transfer fluid (which may in particular be R-410A).

In certain embodiments, the heat transfer fluid of the invention is what is referred to as a replacement heat transfer fluid, that is to say that it is used in a heat transfer apparatus which was previously used to implement a heat transfer process with another heat transfer fluid, called the initial heat transfer fluid (which may in particular be R-410A).

The two preceding paragraphs correspond to the assumption of a replacement.

In some embodiments, the process of the invention comprises in succession:
implementation with the initial heat transfer fluid;
replacement of the initial heat transfer fluid by the replacement heat transfer fluid (according to the invention); and
implementation with the replacement heat transfer fluid.

In other embodiments, the apparatus is implemented directly with the replacement heat transfer fluid, without being implemented with the initial heat transfer fluid despite it being suitable, on the basis of its original design, for operating with the initial heat transfer fluid.

This assumption is, by extension, also considered to be a case of “replacement” in the sense of the invention.

The replacement is particularly beneficial when the initial heat transfer fluid has a higher GWP than that of the replacement heat transfer fluid.

In addition to R-410A, the invention also applies in particular to the replacement of R22.

### Heat Transfer Fluid of the Invention

The heat transfer fluid of the invention comprises HFO-1123 and CO₂.

Thus, the heat transfer fluid may comprise, by weight: from 1 to 5% HFO-1123; or from 5 to 10% HFO-1123; or from 10 to 15% HFO-1123; or from 15 to 20% HFO-1123; or from 20 to 25% HFO-1123; or from 25 to 30% HFO-1123; or from 30 to 35% HFO-1123; or from 35 to 40% HFO-1123; or from 40 to 45% HFO-1123; or from 45 to 50% HFO-1123; or from 50 to 55% HFO-1123; or from 55 to 60% HFO-1123; or from 60 to 65% HFO-1123; or from 65 to 70% HFO-1123; or from 70 to 75% HFO-1123; or from 75 to 80% HFO-1123; or from 80 to 85% HFO-1123; or from 85 to 90% HFO-1123; or from 90 to 95% HFO-1123; or from 95 to 99% HFO-1123. In some embodiments, it is preferable for the content of HFO-1123 not to be too high, in view of the tendency of this compound to exhibit explosive properties when not mixed with sufficient contents of other non-explosive compounds.

The heat transfer fluid can comprise, by weight: from 1 to 5% CO₂; or from 5 to 10% CO₂; or from 10 to 15% CO₂; or from 15 to 20% CO₂; or from 20 to 25% CO₂; or from 25 to 30% CO₂; or from 30 to 35% CO₂; or from 35 to 40% CO₂; or from 40 to 45% CO₂; or from 45 to 50% CO₂; or from 50 to 55% CO₂; or from 55 to 60% CO₂; or from 60 to 65% CO₂; or from 65 to 70% CO₂; or from 70 to 75% CO₂; or from 75 to 80% CO₂; or from 80 to 85% CO₂; or from 85 to 90% CO₂; or from 90 to 95% CO₂; or from 95 to 99% CO₂.

The heat transfer fluid may optionally also comprise one or more other heat transfer compounds, in addition to HFO-1123 and CO₂.

The heat transfer fluid can thus be:
a binary composition (consisting, or consisting essentially, except for impurities, of HFO-1123 and CO₂);
a ternary composition (consisting, or consisting essentially, except for impurities, of three heat transfer compounds);
a quaternary composition (consisting, or consisting essentially, except for impurities, of four heat transfer compounds);
a quinary composition (consisting, or consisting essentially, except for impurities, of five heat transfer compounds);
a senary composition (consisting, or consisting essentially, except for impurities, of six heat transfer compounds); or
a septenary composition (consisting, or consisting essentially, except for impurities, of seven heat transfer compounds).

When a compound exists in the form of stereoisomers (in particular cis/trans or Z/E), by convention the mixtures of two stereoisomers count as a single compound for the purposes of the above classification.

The heat transfer compounds which may be present in the composition, in addition to HFO-1123 and CO₂, may in particular be chosen from:
ammonia;
alkanes, and in particular propane;
alkenes, and in particular propylene;
hydrofluoroolefins, and in particular 2,3,3,3-tetrafluoropropene (HFO-1234yf), 1,3,3,3-tetrafluoropropene (HFO-1234ze) and 1,1,1,4,4,4-hexafluorobut-2-ene (HFO-1336mzz); it being understood that the term “HFO-1234ze” denotes either the Z form or the E form of the compound, or a mixture of the two forms, and preferably denotes the E form or a mixture containing at least 90% by weight of E form, or at least 95% by weight of E form, or at least 99% by weight of E form; and it being understood that the term “HFO-1336mzz” denotes either the Z form or the E form of the compound, or a mixture of the two forms;
hydrochlorofluoroolefins, and in particular 1-chloro-3,3,3-tetrafluoropropene (HCFO-1233zd); it being understood that the term “HFO-1233zd” denotes either the Z form or the E form of the compound, or a mixture of the two forms, and preferably denotes the E form or a mixture containing at least 90% by weight of E form, or at least 95% by weight of E form, or at least 99% by weight of E form;
saturated hydrofluorocarbons, and in particular:
   1,1,1,2-tetrafluoroethane (HFC-134a);
   pentafluoroethane (HFC-125);
   difluoromethane (HFC-32);
   1,1,1,2,3,3,3-heptafluoropropane (HFC-227ea);
   1,1,1-trifluoroethane (R-143a);
   1,1,1,3,3-pentafluoropropane (HFC-245fa);
   1,1,2,2-tetrafluoroethane (HFC-134);
   1,1-difluoroethane (HFC-152a).

HFO-1234yf, HFO-1234ze, HFC-134a, HFC-125 and HFC-32 are more particularly preferred.

HFC-134a, HFC-125 and HFC-32 are most particularly preferred.

In some embodiments, the heat transfer fluid, in addition to HFO-1123 and CO₂, comprises:
HFC-134a, and optionally one or more other compounds chosen from the compounds above and preferably chosen from HFO-1234yf, HFO-1234ze, HFC-125 and HFC-32; or
HFC-32, and optionally one or more other compounds chosen from the compounds above and preferably chosen from HFO-1234yf, HFO-1234ze, HFC-125 and HFC-134a; or
HFC-125, and optionally one or more other compounds chosen from the compounds above and preferably chosen from HFO-1234yf, HFO-1234ze, HFC-32 and HFC-134a; or
HFO-1234yf, and optionally one or more other compounds chosen from the compounds above and preferably chosen from HFO-1234ze, HFO-32, HFC-125 and HFC-134a; or
HFO-1234ze, and optionally one or more other compounds chosen from the compounds above and preferably chosen from HFO-1234yf, HFO-32, HFC-125 and HFC-134a.

In some embodiments, the heat transfer fluid is:
a ternary composition of HFO-1123, CO₂ and HFC-134a; or
a ternary composition of HFO-1123, CO₂ and HFC-32; or
a ternary composition of HFO-1123, CO₂ and HFC-125; or
a ternary composition of HFO-1123, CO₂ and HFO-1234yf; or
a ternary composition of HFO-1123, CO₂ and HFO-1234ze; or
a quaternary composition of HFO-1123, CO₂, HFC-134a and HFC-32; or
a quaternary composition of HFO-1123, CO₂, HFC-134a and HFC-125; or
a quaternary composition of HFO-1123, CO₂, HFC-134a and HFO-1234yf; or
   a quaternary composition of HFO-1123, CO₂, HFC-134a and HFO-1234ze; or
   a quaternary composition of HFO-1123, CO₂, HFC-125 and HFC-32; or
a quaternary composition of HFO-1123, CO₂, HFC-125 and HFO-1234yf; or
a quaternary composition of HFO-1123, CO₂, HFC-125 and HFO-1234ze; or
a quaternary composition of HFO-1123, CO₂, HFC-32 and HFO-1234yf; or
a quaternary composition of HFO-1123, CO₂, HFC-32 and HFO-1234ze; or
a quaternary composition of HFO-1123, CO₂, HFO-1234yf and HFO-1234ze; or
a quinary composition of HFO-1123, CO₂, HFC-134a, HFC-32 and HFC-125; or
a quinary composition of HFO-1123, CO₂, HFC-134a, HFC-32 and HFO-1234yf; or
a quinary composition of HFO-1123, CO₂, HFC-134a, HFC-32 and HFO-1234ze; or
a quinary composition of HFO-1123, CO₂, HFC-134a, HFC-125 and HFO-1234yf; or
a quinary composition of HFO-1123, CO₂, HFC-134a, HFC-125 and HFO-1234ze; or
a quinary composition of HFO-1123, CO₂, HFC-134a, HFO-1234yf and HFO-1234ze; or
a senary composition of HFO-1123, CO₂, HFC-134a, HFC-32, HFC-125 and HFO-1234yf; or
a senary composition of HFO-1123, CO₂, HFC-134a, HFC-32, HFC-125 and HFO-1234ze; or
a septenary composition of HFO-1123, CO₂, HFC-134a, HFC-32, HFC-125, HFO-1234yf and HFO-1234ze.

In some embodiments, the heat transfer fluid consists essentially (or even consists) of the heat transfer compounds present in the weight ranges which are shown in the tables below:

TABLE A
Compositions consisting essentially (or
even consisting) of HFO-1123 and CO₂

| Composition | | |
|---|---|---|
| No. | HFO-1123 | CO₂ |
| A1 | 1-10% | 90-99% |
| A2 | 10-20% | 80-90% |
| A3 | 20-30% | 70-80% |
| A4 | 30-40% | 60-70% |
| A5 | 40-50% | 50-60% |
| A6 | 50-60% | 40-50% |
| A7 | 60-70% | 30-40% |
| A8 | 70-80% | 20-30% |
| A9 | 80-90% | 10-20% |
| A10 | 90-99% | 1-10% |

TABLE B
Compositions consisting essentially (or even
consisting) of HFO-1123, CO₂ and HFC-125

| Composition | | | |
|---|---|---|---|
| No. | HFO-1123 | CO₂ | HFC-125 |
| B1 | 1-10% | 1-10% | 80-90% |
| B2 | 1-10% | 1-10% | 90-98% |
| B3 | 1-10% | 10-20% | 70-80% |
| B4 | 1-10% | 10-20% | 80-89% |
| B5 | 1-10% | 20-30% | 60-70% |
| B6 | 1-10% | 20-30% | 70-79% |
| B7 | 1-10% | 30-40% | 50-60% |
| B8 | 1-10% | 30-40% | 60-69% |
| B9 | 1-10% | 40-50% | 40-50% |
| B10 | 1-10% | 40-50% | 50-59% |
| B11 | 1-10% | 50-60% | 30-40% |
| B12 | 1-10% | 50-60% | 40-49% |
| B13 | 1-10% | 60-70% | 20-30% |
| B14 | 1-10% | 60-70% | 30-39% |
| B15 | 1-10% | 70-80% | 10-20% |
| B16 | 1-10% | 70-80% | 20-29% |
| B17 | 1-10% | 80-90% | 1-10% |
| B18 | 1-10% | 80-90% | 10-19% |
| B19 | 1-9% | 90-98% | 1-9% |
| B20 | 10-20% | 1-10% | 70-80% |
| B21 | 10-20% | 1-10% | 80-89% |
| B22 | 10-20% | 10-20% | 60-70% |
| B23 | 10-20% | 10-20% | 70-80% |
| B24 | 10-20% | 20-30% | 50-60% |
| B25 | 10-20% | 20-30% | 60-70% |
| B26 | 10-20% | 30-40% | 40-50% |
| B27 | 10-20% | 30-40% | 50-60% |
| B28 | 10-20% | 40-50% | 30-40% |
| B29 | 10-20% | 40-50% | 40-50% |
| B30 | 10-20% | 50-60% | 20-30% |
| B31 | 10-20% | 50-60% | 30-40% |
| B32 | 10-20% | 60-70% | 10-20% |
| B33 | 10-20% | 60-70% | 20-30% |
| B34 | 10-20% | 70-80% | 1-10% |
| B35 | 10-20% | 70-80% | 10-20% |
| B36 | 10-19% | 80-89% | 1-10% |
| B37 | 20-30% | 1-10% | 60-70% |
| B38 | 20-30% | 1-10% | 70-79% |
| B39 | 20-30% | 10-20% | 50-60% |
| B40 | 20-30% | 10-20% | 60-70% |
| B41 | 20-30% | 20-30% | 40-50% |
| B42 | 20-30% | 20-30% | 50-60% |
| B43 | 20-30% | 30-40% | 30-40% |
| B44 | 20-30% | 30-40% | 40-50% |
| B45 | 20-30% | 40-50% | 20-30% |
| B46 | 20-30% | 40-50% | 30-40% |
| B47 | 20-30% | 50-60% | 10-20% |
| B48 | 20-30% | 50-60% | 20-30% |
| B49 | 20-30% | 60-70% | 1-10% |
| B50 | 20-30% | 60-70% | 10-20% |
| B51 | 20-29% | 70-79% | 1-10% |
| B52 | 30-40% | 1-10% | 50-60% |
| B53 | 30-40% | 1-10% | 60-69% |
| B54 | 30-40% | 10-20% | 40-50% |
| B55 | 30-40% | 10-20% | 50-60% |
| B56 | 30-40% | 20-30% | 30-40% |
| B57 | 30-40% | 20-30% | 40-50% |
| B58 | 30-40% | 30-40% | 20-30% |
| B59 | 30-40% | 30-40% | 30-40% |
| B60 | 30-40% | 40-50% | 10-20% |
| B61 | 30-40% | 40-50% | 20-30% |
| B62 | 30-40% | 50-60% | 1-10% |
| B63 | 30-40% | 50-60% | 10-20% |
| B64 | 30-39% | 60-69% | 1-10% |
| B65 | 40-50% | 1-10% | 40-50% |
| B66 | 40-50% | 1-10% | 50-59% |
| B67 | 40-50% | 10-20% | 30-40% |
| B68 | 40-50% | 10-20% | 40-50% |
| B69 | 40-50% | 20-30% | 20-30% |
| B70 | 40-50% | 20-30% | 30-40% |
| B71 | 40-50% | 30-40% | 10-20% |
| B72 | 40-50% | 20-30% | 20-30% |
| B73 | 40-50% | 40-50% | 1-10% |
| B74 | 40-50% | 40-50% | 10-20% |
| B75 | 40-49% | 50-59% | 1-10% |
| B76 | 50-60% | 1-10% | 30-40% |
| B77 | 50-60% | 1-10% | 40-49% |
| B78 | 50-60% | 10-20% | 20-30% |
| B79 | 50-60% | 10-20% | 30-40% |
| B80 | 50-60% | 20-30% | 10-20% |
| B81 | 50-60% | 20-30% | 20-30% |
| B82 | 50-60% | 30-40% | 1-10% |
| B83 | 50-60% | 30-40% | 10-20% |
| B84 | 50-59% | 40-49% | 1-10% |
| B85 | 60-70% | 1-10% | 20-30% |
| B86 | 60-70% | 1-10% | 30-39% |
| B87 | 60-70% | 10-20% | 10-20% |
| B88 | 60-70% | 10-20% | 20-30% |
| B89 | 60-70% | 20-30% | 1-10% |
| B90 | 60-70% | 20-30% | 10-20% |
| B91 | 60-69% | 30-39% | 1-10% |
| B92 | 70-80% | 1-10% | 10-20% |
| B93 | 70-80% | 1-10% | 20-29% |
| B94 | 70-80% | 10-20% | 1-10% |
| B95 | 70-80% | 10-20% | 10-20% |
| B96 | 70-79% | 20-29% | 1-10% |
| B97 | 80-90% | 1-10% | 1-10% |
| B98 | 80-90% | 1-10% | 10-19% |
| B99 | 80-89% | 10-19% | 1-10% |
| B100 | 90-98% | 1-9% | 1-9% |

TABLE C
Compositions consisting essentially (or even
consisting) of HFO-1123, CO₂ and HFC-134a

| Composition | | | |
|---|---|---|---|
| No. | HFO-1123 | CO₂ | HFC-134a |
| C1 | 1-10% | 1-10% | 80-90% |
| C2 | 1-10% | 1-10% | 90-98% |
| C3 | 1-10% | 10-20% | 70-80% |
| C4 | 1-10% | 10-20% | 80-89% |
| C5 | 1-10% | 20-30% | 60-70% |
| C6 | 1-10% | 20-30% | 70-79% |
| C7 | 1-10% | 30-40% | 50-60% |
| C8 | 1-10% | 30-40% | 60-69% |
| C9 | 1-10% | 40-50% | 40-50% |
| C10 | 1-10% | 40-50% | 50-59% |
| C11 | 1-10% | 50-60% | 30-40% |
| C12 | 1-10% | 50-60% | 40-49% |
| C13 | 1-10% | 60-70% | 20-30% |
| C14 | 1-10% | 60-70% | 30-39% |
| C15 | 1-10% | 70-80% | 10-20% |
| C16 | 1-10% | 70-80% | 20-29% |
| C17 | 1-10% | 80-90% | 1-10% |
| C18 | 1-10% | 80-90% | 10-19% |
| C19 | 1-9% | 90-98% | 1-9% |
| C20 | 10-20% | 1-10% | 70-80% |
| C21 | 10-20% | 1-10% | 80-89% |
| C22 | 10-20% | 10-20% | 60-70% |
| C23 | 10-20% | 10-20% | 70-80% |
| C24 | 10-20% | 20-30% | 50-60% |
| C25 | 10-20% | 20-30% | 60-70% |
| C26 | 10-20% | 30-40% | 40-50% |
| C27 | 10-20% | 30-40% | 50-60% |
| C28 | 10-20% | 40-50% | 30-40% |
| C29 | 10-20% | 40-50% | 40-50% |
| C30 | 10-20% | 50-60% | 20-30% |
| C31 | 10-20% | 50-60% | 30-40% |
| C32 | 10-20% | 60-70% | 10-20% |
| C33 | 10-20% | 60-70% | 20-30% |
| C34 | 10-20% | 70-80% | 1-10% |
| C35 | 10-20% | 70-80% | 10-20% |
| C36 | 10-19% | 80-89% | 1-10% |
| C37 | 20-30% | 1-10% | 60-70% |
| C38 | 20-30% | 1-10% | 70-79% |
| C39 | 20-30% | 10-20% | 50-60% |
| C40 | 20-30% | 10-20% | 60-70% |
| C41 | 20-30% | 20-30% | 40-50% |
| C42 | 20-30% | 20-30% | 50-60% |
| C43 | 20-30% | 30-40% | 30-40% |
| C44 | 20-30% | 30-40% | 40-50% |
| C45 | 20-30% | 40-50% | 20-30% |
| C46 | 20-30% | 40-50% | 30-40% |
| C47 | 20-30% | 50-60% | 10-20% |
| C48 | 20-30% | 50-60% | 20-30% |
| C49 | 20-30% | 60-70% | 1-10% |
| C50 | 20-30% | 60-70% | 10-20% |
| C51 | 20-29% | 70-79% | 1-10% |
| C52 | 30-40% | 1-10% | 50-60% |
| C53 | 30-40% | 1-10% | 60-69% |
| C54 | 30-40% | 10-20% | 40-50% |
| C55 | 30-40% | 10-20% | 50-60% |
| C56 | 30-40% | 20-30% | 30-40% |
| C57 | 30-40% | 20-30% | 40-50% |
| C58 | 30-40% | 30-40% | 20-30% |
| C59 | 30-40% | 30-40% | 30-40% |
| C60 | 30-40% | 40-50% | 10-20% |
| C61 | 30-40% | 40-50% | 20-30% |
| C62 | 30-40% | 50-60% | 1-10% |
| C63 | 30-40% | 50-60% | 10-20% |
| C64 | 30-39% | 60-69% | 1-10% |
| C65 | 40-50% | 1-10% | 40-50% |
| C66 | 40-50% | 1-10% | 50-59% |
| C67 | 40-50% | 10-20% | 30-40% |
| C68 | 40-50% | 10-20% | 40-50% |
| C69 | 40-50% | 20-30% | 20-30% |
| C70 | 40-50% | 20-30% | 30-40% |
| C71 | 40-50% | 30-40% | 10-20% |
| C72 | 40-50% | 20-30% | 20-30% |
| C73 | 40-50% | 40-50% | 1-10% |
| C74 | 40-50% | 40-50% | 10-20% |
| C75 | 40-49% | 50-59% | 1-10% |
| C76 | 50-60% | 1-10% | 30-40% |
| C77 | 50-60% | 1-10% | 40-49% |
| C78 | 50-60% | 10-20% | 20-30% |
| C79 | 50-60% | 10-20% | 30-40% |
| C80 | 50-60% | 20-30% | 10-20% |
| C81 | 50-60% | 20-30% | 20-30% |
| C82 | 50-60% | 30-40% | 1-10% |
| C83 | 50-60% | 30-40% | 10-20% |
| C84 | 50-59% | 40-49% | 1-10% |
| C85 | 60-70% | 1-10% | 20-30% |
| C86 | 60-70% | 1-10% | 30-39% |
| C87 | 60-70% | 10-20% | 10-20% |
| C88 | 60-70% | 10-20% | 20-30% |
| C89 | 60-70% | 20-30% | 1-10% |
| C90 | 60-70% | 20-30% | 10-20% |
| C91 | 60-69% | 30-39% | 1-10% |
| C92 | 70-80% | 1-10% | 10-20% |
| C93 | 70-80% | 1-10% | 20-29% |
| C94 | 70-80% | 10-20% | 1-10% |
| C95 | 70-80% | 10-20% | 10-20% |
| C96 | 70-79% | 20-29% | 1-10% |
| C97 | 80-90% | 1-10% | 1-10% |
| C98 | 80-90% | 1-10% | 10-19% |
| C99 | 80-89% | 10-19% | 1-10% |
| C100 | 90-98% | 1-9% | 1-9% |

TABLE D
Compositions consisting essentially (or even
consisting) of HFO-1123, CO₂ and HFC-32

| Composition | | | |
|---|---|---|---|
| No. | HFO-1123 | CO₂ | HFC-32 |
| D1 | 1-10% | 1-10% | 80-90% |
| D2 | 1-10% | 1-10% | 90-98% |
| D3 | 1-10% | 10-20% | 70-80% |
| D4 | 1-10% | 10-20% | 80-89% |
| D5 | 1-10% | 20-30% | 60-70% |
| D6 | 1-10% | 20-30% | 70-79% |
| D7 | 1-10% | 30-40% | 50-60% |
| D8 | 1-10% | 30-40% | 60-69% |
| D9 | 1-10% | 40-50% | 40-50% |
| D10 | 1-10% | 40-50% | 50-59% |
| D11 | 1-10% | 50-60% | 30-40% |
| D12 | 1-10% | 50-60% | 40-49% |
| D13 | 1-10% | 60-70% | 20-30% |
| D14 | 1-10% | 60-70% | 30-39% |
| D15 | 1-10% | 70-80% | 10-20% |
| D16 | 1-10% | 70-80% | 20-29% |
| D17 | 1-10% | 80-90% | 1-10% |
| D18 | 1-10% | 80-90% | 10-19% |
| D19 | 1-9% | 90-98% | 1-9% |
| D20 | 10-20% | 1-10% | 70-80% |
| D21 | 10-20% | 1-10% | 80-89% |
| D22 | 10-20% | 10-20% | 60-70% |
| D23 | 10-20% | 10-20% | 70-80% |
| D24 | 10-20% | 20-30% | 50-60% |
| D25 | 10-20% | 20-30% | 60-70% |
| D26 | 10-20% | 30-40% | 40-50% |
| D27 | 10-20% | 30-40% | 50-60% |
| D28 | 10-20% | 40-50% | 30-40% |
| D29 | 10-20% | 40-50% | 40-50% |
| D30 | 10-20% | 50-60% | 20-30% |
| D31 | 10-20% | 50-60% | 30-40% |
| D32 | 10-20% | 60-70% | 10-20% |
| D33 | 10-20% | 60-70% | 20-30% |
| D34 | 10-20% | 70-80% | 1-10% |
| D35 | 10-20% | 70-80% | 10-20% |
| D36 | 10-19% | 80-89% | 1-10% |
| D37 | 20-30% | 1-10% | 60-70% |
| D38 | 20-30% | 1-10% | 70-79% |
| D39 | 20-30% | 10-20% | 50-60% |
| D40 | 20-30% | 10-20% | 60-70% |
| D41 | 20-30% | 20-30% | 40-50% |
| D42 | 20-30% | 20-30% | 50-60% |
| D43 | 20-30% | 30-40% | 30-40% |
| D44 | 20-30% | 30-40% | 40-50% |
| D45 | 20-30% | 40-50% | 20-30% |
| D46 | 20-30% | 40-50% | 30-40% |
| D47 | 20-30% | 50-60% | 10-20% |
| D48 | 20-30% | 50-60% | 20-30% |
| D49 | 20-30% | 60-70% | 1-10% |
| D50 | 20-30% | 60-70% | 10-20% |
| D51 | 20-29% | 70-79% | 1-10% |
| D52 | 30-40% | 1-10% | 50-60% |
| D53 | 30-40% | 1-10% | 60-69% |
| D54 | 30-40% | 10-20% | 40-50% |
| D55 | 30-40% | 10-20% | 50-60% |
| D56 | 30-40% | 20-30% | 30-40% |
| D57 | 30-40% | 20-30% | 40-50% |
| D58 | 30-40% | 30-40% | 20-30% |
| D59 | 30-40% | 30-40% | 30-40% |
| D60 | 30-40% | 40-50% | 10-20% |
| D61 | 30-40% | 40-50% | 20-30% |
| D62 | 30-40% | 50-60% | 1-10% |
| D63 | 30-40% | 50-60% | 10-20% |
| D64 | 30-39% | 60-69% | 1-10% |
| D65 | 40-50% | 1-10% | 40-50% |
| D66 | 40-50% | 1-10% | 50-59% |
| D67 | 40-50% | 10-20% | 30-40% |
| D68 | 40-50% | 10-20% | 40-50% |
| D69 | 40-50% | 20-30% | 20-30% |
| D70 | 40-50% | 20-30% | 30-40% |
| D71 | 40-50% | 30-40% | 10-20% |
| D72 | 40-50% | 20-30% | 20-30% |
| D73 | 40-50% | 40-50% | 1-10% |
| D74 | 40-50% | 40-50% | 10-20% |
| D75 | 40-49% | 50-59% | 1-10% |
| D76 | 50-60% | 1-10% | 30-40% |
| D77 | 50-60% | 1-10% | 40-49% |
| D78 | 50-60% | 10-20% | 20-30% |
| D79 | 50-60% | 10-20% | 30-40% |
| D80 | 50-60% | 20-30% | 10-20% |
| D81 | 50-60% | 20-30% | 20-30% |
| D82 | 50-60% | 30-40% | 1-10% |
| D83 | 50-60% | 30-40% | 10-20% |
| D84 | 50-59% | 40-49% | 1-10% |
| D85 | 60-70% | 1-10% | 20-30% |
| D86 | 60-70% | 1-10% | 30-39% |
| D87 | 60-70% | 10-20% | 10-20% |
| D88 | 60-70% | 10-20% | 20-30% |
| D89 | 60-70% | 20-30% | 1-10% |
| D90 | 60-70% | 20-30% | 10-20% |
| D91 | 60-69% | 30-39% | 1-10% |
| D92 | 70-80% | 1-10% | 10-20% |
| D93 | 70-80% | 1-10% | 20-29% |
| D94 | 70-80% | 10-20% | 1-10% |
| D95 | 70-80% | 10-20% | 10-20% |
| D96 | 70-79% | 20-29% | 1-10% |
| D97 | 80-90% | 1-10% | 1-10% |
| D98 | 80-90% | 1-10% | 10-19% |
| D99 | 80-89% | 10-19% | 1-10% |
| D100 | 90-98% | 1-9% | 1-9% |

TABLE E
Compositions consisting essentially (or even consisting)
of HFO-1123, CO₂, HFC-125 and HFC-134a

| Composition | | | | |
|---|---|---|---|---|
| No. | HFO-1123 | CO₂ | HFC-125 | HFC-134a |
| E1 | 1-20% | 1-20% | 1-20% | 40-60% |
| E2 | 1-20% | 1-20% | 1-20% | 60-80% |
| E3 | 1-18% | 1-18% | 1-18% | 80-97% |
| E4 | 1-20% | 1-20% | 20-40% | 20-40% |
| E5 | 1-20% | 1-20% | 20-40% | 40-60% |
| E6 | 1-19% | 1-19% | 20-38% | 60-78% |
| E7 | 1-20% | 1-20% | 40-60% | 1-20% |
| E8 | 1-20% | 1-20% | 40-60% | 20-40% |
| E9 | 1-19% | 1-19% | 40-58% | 40-58% |
| E10 | 1-20% | 1-20% | 60-80% | 1-20% |
| E11 | 1-19% | 1-19% | 60-78% | 20-38% |
| E12 | 1-18% | 1-18% | 80-97% | 1-18% |
| E13 | 1-20% | 20-40% | 1-20% | 20-40% |
| E14 | 1-20% | 20-40% | 1-20% | 40-60% |
| E15 | 1-19% | 20-38% | 1-19% | 60-78% |
| E16 | 1-20% | 20-40% | 20-40% | 1-20% |
| E17 | 1-20% | 20-40% | 20-40% | 20-40% |
| E18 | 1-20% | 20-39% | 20-39% | 40-59% |
| E19 | 1-20% | 20-40% | 40-60% | 1-20% |
| E20 | 1-20% | 20-39% | 40-59% | 20-39% |
| E21 | 1-19% | 20-38% | 60-78% | 1-19% |
| E22 | 1-20% | 40-60% | 1-20% | 1-20% |
| E23 | 1-20% | 40-60% | 1-20% | 20-40% |
| E24 | 1-19% | 40-58% | 1-19% | 40-58% |
| E25 | 1-20% | 40-60% | 20-40% | 1-20% |
| E26 | 1-20% | 40-59% | 20-39% | 20-39% |
| E27 | 1-19% | 40-58% | 40-58% | 1-19% |
| E28 | 1-20% | 60-80% | 1-20% | 1-20% |
| E29 | 1-19% | 60-78% | 1-19% | 20-38% |
| E30 | 1-19% | 60-78% | 20-38% | 1-19% |
| E31 | 1-18% | 80-97% | 1-18% | 1-18% |
| E32 | 20-40% | 1-20% | 1-20% | 20-40% |
| E33 | 20-40% | 1-20% | 1-20% | 40-60% |
| E34 | 20-38% | 1-19% | 1-19% | 60-78% |
| E35 | 20-40% | 1-20% | 20-40% | 1-20% |
| E36 | 20-40% | 1-20% | 20-40% | 20-40% |
| E37 | 20-39% | 1-20% | 20-39% | 40-59% |
| E38 | 20-40% | 1-20% | 40-60% | 1-20% |
| E39 | 20-39% | 1-20% | 40-59% | 20-39% |
| E40 | 20-38% | 1-19% | 60-78% | 1-19% |
| E41 | 20-40% | 20-40% | 1-20% | 1-20% |
| E42 | 20-40% | 20-40% | 1-20% | 20-40% |
| E43 | 20-39% | 20-39% | 1-20% | 40-59% |
| E44 | 20-40% | 20-40% | 20-40% | 1-20% |
| E45 | 20-40% | 20-40% | 20-40% | 20-40% |
| E46 | 20-39% | 20-39% | 40-59% | 1-20% |
| E47 | 20-40% | 40-60% | 1-20% | 1-20% |
| E48 | 20-39% | 40-59% | 1-20% | 20-39% |
| E49 | 20-39% | 40-59% | 20-39% | 1-20% |
| E50 | 20-38% | 60-78% | 1-19% | 1-19% |
| E51 | 40-60% | 1-20% | 1-20% | 1-20% |
| E52 | 40-60% | 1-20% | 1-20% | 20-40% |
| E53 | 40-58% | 1-19% | 1-19% | 40-58% |
| E54 | 40-60% | 1-20% | 20-40% | 1-20% |
| E55 | 40-59% | 1-20% | 20-39% | 20-39% |
| E56 | 40-58% | 1-19% | 40-58% | 1-19% |
| E57 | 40-60% | 20-40% | 1-20% | 1-20% |
| E58 | 40-59% | 20-39% | 1-20% | 20-39% |
| E59 | 40-59% | 20-39% | 20-39% | 1-20% |
| E60 | 40-58% | 40-58% | 1-19% | 1-19% |
| E61 | 60-80% | 1-20% | 1-20% | 1-20% |
| E62 | 60-78% | 1-19% | 1-19% | 20-38% |
| E63 | 60-78% | 1-19% | 20-38% | 1-19% |
| E64 | 60-78% | 20-38% | 1-19% | 1-19% |
| E65 | 80-97% | 1-18% | 1-18% | 1-18% |

TABLE F
Compositions consisting essentially (or even consisting)
of HFO-1123, CO₂, HFC-125 and HFC-32

| Composition | | | | |
|---|---|---|---|---|
| No. | HFO-1123 | CO₂ | HFC-125 | HFC-32 |
| F1 | 1-20% | 1-20% | 1-20% | 40-60% |
| F2 | 1-20% | 1-20% | 1-20% | 60-80% |
| F3 | 1-18% | 1-18% | 1-18% | 80-97% |
| F4 | 1-20% | 1-20% | 20-40% | 20-40% |
| F5 | 1-20% | 1-20% | 20-40% | 40-60% |
| F6 | 1-19% | 1-19% | 20-38% | 60-78% |
| F7 | 1-20% | 1-20% | 40-60% | 1-20% |
| F8 | 1-20% | 1-20% | 40-60% | 20-40% |
| F9 | 1-19% | 1-19% | 40-58% | 40-58% |
| F10 | 1-20% | 1-20% | 60-80% | 1-20% |
| F11 | 1-19% | 1-19% | 60-78% | 20-38% |
| F12 | 1-18% | 1-18% | 80-97% | 1-18% |
| F13 | 1-20% | 20-40% | 1-20% | 20-40% |
| F14 | 1-20% | 20-40% | 1-20% | 40-60% |
| F15 | 1-19% | 20-38% | 1-19% | 60-78% |
| F16 | 1-20% | 20-40% | 20-40% | 1-20% |
| F17 | 1-20% | 20-40% | 20-40% | 20-40% |
| F18 | 1-20% | 20-39% | 20-39% | 40-59% |
| F19 | 1-20% | 20-40% | 40-60% | 1-20% |
| F20 | 1-20% | 20-39% | 40-59% | 20-39% |
| F21 | 1-19% | 20-38% | 60-78% | 1-19% |
| F22 | 1-20% | 40-60% | 1-20% | 1-20% |
| F23 | 1-20% | 40-60% | 1-20% | 20-40% |
| F24 | 1-19% | 40-58% | 1-19% | 40-58% |
| F25 | 1-20% | 40-60% | 20-40% | 1-20% |
| F26 | 1-20% | 40-59% | 20-39% | 20-39% |
| F27 | 1-19% | 40-58% | 40-58% | 1-19% |
| F28 | 1-20% | 60-80% | 1-20% | 1-20% |
| F29 | 1-19% | 60-78% | 1-19% | 20-38% |
| F30 | 1-19% | 60-78% | 20-38% | 1-19% |
| F31 | 1-18% | 80-97% | 1-18% | 1-18% |
| F32 | 20-40% | 1-20% | 1-20% | 20-40% |
| F33 | 20-40% | 1-20% | 1-20% | 40-60% |
| F34 | 20-38% | 1-19% | 1-19% | 60-78% |
| F35 | 20-40% | 1-20% | 20-40% | 1-20% |
| F36 | 20-40% | 1-20% | 20-40% | 20-40% |
| F37 | 20-39% | 1-20% | 20-39% | 40-59% |
| F38 | 20-40% | 1-20% | 40-60% | 1-20% |
| F39 | 20-39% | 1-20% | 40-59% | 20-39% |
| F40 | 20-38% | 1-19% | 60-78% | 1-19% |
| F41 | 20-40% | 20-40% | 1-20% | 1-20% |
| F42 | 20-40% | 20-40% | 1-20% | 20-40% |
| F43 | 20-39% | 20-39% | 1-20% | 40-59% |
| F44 | 20-40% | 20-40% | 20-40% | 1-20% |
| F45 | 20-40% | 20-40% | 20-40% | 20-40% |
| F46 | 20-39% | 20-39% | 40-59% | 1-20% |
| F47 | 20-40% | 40-60% | 1-20% | 1-20% |
| F48 | 20-39% | 40-59% | 1-20% | 20-39% |
| F49 | 20-39% | 40-59% | 20-39% | 1-20% |
| F50 | 20-38% | 60-78% | 1-19% | 1-19% |
| F51 | 40-60% | 1-20% | 1-20% | 1-20% |
| F52 | 40-60% | 1-20% | 1-20% | 20-40% |
| F53 | 40-58% | 1-19% | 1-19% | 40-58% |
| F54 | 40-60% | 1-20% | 20-40% | 1-20% |
| F55 | 40-59% | 1-20% | 20-39% | 20-39% |
| F56 | 40-58% | 1-19% | 40-58% | 1-19% |
| F57 | 40-60% | 20-40% | 1-20% | 1-20% |
| F58 | 40-59% | 20-39% | 1-20% | 20-39% |
| F59 | 40-59% | 20-39% | 20-39% | 1-20% |
| F60 | 40-58% | 40-58% | 1-19% | 1-19% |
| F61 | 60-80% | 1-20% | 1-20% | 1-20% |
| F62 | 60-78% | 1-19% | 1-19% | 20-38% |
| F63 | 60-78% | 1-19% | 20-38% | 1-19% |
| F64 | 60-78% | 20-38% | 1-19% | 1-19% |
| F65 | 80-97% | 1-18% | 1-18% | 1-18% |

TABLE G
Compositions consisting essentially (or even consisting)
of HFO-1123, CO₂, HFC-32 and HFC-134a

| Composition | | | | |
|---|---|---|---|---|
| No. | HFO-1123 | CO₂ | HFC-32 | HFC-134a |
| G1 | 1-20% | 1-20% | 1-20% | 40-60% |
| G2 | 1-20% | 1-20% | 1-20% | 60-80% |
| G3 | 1-18% | 1-18% | 1-18% | 80-97% |
| G4 | 1-20% | 1-20% | 20-40% | 20-40% |
| G5 | 1-20% | 1-20% | 20-40% | 40-60% |
| G6 | 1-19% | 1-19% | 20-38% | 60-78% |
| G7 | 1-20% | 1-20% | 40-60% | 1-20% |
| G8 | 1-20% | 1-20% | 40-60% | 20-40% |
| G9 | 1-19% | 1-19% | 40-58% | 40-58% |
| G10 | 1-20% | 1-20% | 60-80% | 1-20% |
| G11 | 1-19% | 1-19% | 60-78% | 20-38% |
| G12 | 1-18% | 1-18% | 80-97% | 1-18% |
| G13 | 1-20% | 20-40% | 1-20% | 20-40% |
| G14 | 1-20% | 20-40% | 1-20% | 40-60% |
| G15 | 1-19% | 20-38% | 1-19% | 60-78% |
| G16 | 1-20% | 20-40% | 20-40% | 1-20% |
| G17 | 1-20% | 20-40% | 20-40% | 20-40% |
| G18 | 1-20% | 20-39% | 20-39% | 40-59% |
| G19 | 1-20% | 20-40% | 40-60% | 1-20% |
| G20 | 1-20% | 20-39% | 40-59% | 20-39% |
| G21 | 1-19% | 20-38% | 60-78% | 1-19% |
| G22 | 1-20% | 40-60% | 1-20% | 1-20% |
| G23 | 1-20% | 40-60% | 1-20% | 20-40% |
| G24 | 1-19% | 40-58% | 1-19% | 40-58% |
| G25 | 1-20% | 40-60% | 20-40% | 1-20% |
| G26 | 1-20% | 40-59% | 20-39% | 20-39% |
| G27 | 1-19% | 40-58% | 40-58% | 1-19% |
| G28 | 1-20% | 60-80% | 1-20% | 1-20% |
| G29 | 1-19% | 60-78% | 1-19% | 20-38% |
| G30 | 1-19% | 60-78% | 20-38% | 1-19% |
| G31 | 1-18% | 80-97% | 1-18% | 1-18% |
| G32 | 20-40% | 1-20% | 1-20% | 20-40% |
| G33 | 20-40% | 1-20% | 1-20% | 40-60% |
| G34 | 20-38% | 1-19% | 1-19% | 60-78% |
| G35 | 20-40% | 1-20% | 20-40% | 1-20% |
| G36 | 20-40% | 1-20% | 20-40% | 20-40% |
| G37 | 20-39% | 1-20% | 20-39% | 40-59% |
| G38 | 20-40% | 1-20% | 40-60% | 1-20% |
| G39 | 20-39% | 1-20% | 40-59% | 20-39% |
| G40 | 20-38% | 1-19% | 60-78% | 1-19% |
| G41 | 20-40% | 20-40% | 1-20% | 1-20% |
| G42 | 20-40% | 20-40% | 1-20% | 20-40% |
| G43 | 20-39% | 20-39% | 1-20% | 40-59% |
| G44 | 20-40% | 20-40% | 20-40% | 1-20% |
| G45 | 20-40% | 20-40% | 20-40% | 20-40% |
| G46 | 20-39% | 20-39% | 40-59% | 1-20% |
| G47 | 20-40% | 40-60% | 1-20% | 1-20% |
| G48 | 20-39% | 40-59% | 1-20% | 20-39% |
| G49 | 20-39% | 40-59% | 20-39% | 1-20% |
| G50 | 20-38% | 60-78% | 1-19% | 1-19% |
| G51 | 40-60% | 1-20% | 1-20% | 1-20% |
| G52 | 40-60% | 1-20% | 1-20% | 20-40% |
| G53 | 40-58% | 1-19% | 1-19% | 40-58% |
| G54 | 40-60% | 1-20% | 20-40% | 1-20% |
| G55 | 40-59% | 1-20% | 20-39% | 20-39% |
| G56 | 40-58% | 1-19% | 40-58% | 1-19% |
| G57 | 40-60% | 20-40% | 1-20% | 1-20% |
| G58 | 40-59% | 20-39% | 1-20% | 20-39% |
| G59 | 40-59% | 20-39% | 20-39% | 1-20% |
| G60 | 40-58% | 40-58% | 1-19% | 1-19% |
| G61 | 60-80% | 1-20% | 1-20% | 1-20% |
| G62 | 60-78% | 1-19% | 1-19% | 20-38% |
| G63 | 60-78% | 1-19% | 20-38% | 1-19% |
| G64 | 60-78% | 20-38% | 1-19% | 1-19% |
| G65 | 80-97% | 1-18% | 1-18% | 1-18% |

TABLE H
Compositions consisting essentially (or even consisting)
of HFO-1123, CO₂, HFC-125, HFC-32 and HFC-134a

| Composition | | | | | |
|---|---|---|---|---|---|
| No. | HFO-1123 | CO₂ | HFC-125 | HFC-32 | HFC-134a |
| H1 | 1-20% | 1-20% | 1-20% | 1-20% | 20-40% |
| H2 | 1-20% | 1-20% | 1-20% | 1-20% | 40-60% |
| H3 | 1-20% | 1-20% | 1-20% | 1-20% | 60-80% |
| H4 | 1-17% | 1-17% | 1-17% | 1-17% | 80-96% |
| H5 | 1-20% | 1-20% | 1-20% | 20-40% | 1-20% |
| H6 | 1-20% | 1-20% | 1-20% | 20-40% | 20-40% |
| H7 | 1-20% | 1-20% | 1-20% | 20-40% | 40-60% |
| H8 | 1-18% | 1-18% | 1-18% | 20-37% | 60-77% |
| H9 | 1-20% | 1-20% | 1-20% | 40-60% | 1-20% |
| H10 | 1-20% | 1-20% | 1-20% | 40-60% | 20-40% |
| H11 | 1-18% | 1-18% | 1-18% | 40-57% | 40-57% |
| H12 | 1-20% | 1-20% | 1-20% | 60-80% | 1-20% |
| H13 | 1-18% | 1-18% | 1-18% | 60-77% | 20-37% |
| H14 | 1-17% | 1-17% | 1-17% | 80-96% | 1-17% |
| H15 | 1-20% | 1-20% | 20-40% | 1-20% | 1-20% |
| H16 | 1-20% | 1-20% | 20-40% | 1-20% | 20-40% |
| H17 | 1-20% | 1-20% | 20-40% | 1-20% | 40-60% |
| H18 | 1-18% | 1-18% | 20-37% | 1-18% | 60-77% |
| H19 | 1-20% | 1-20% | 20-40% | 20-40% | 1-20% |
| H20 | 1-20% | 1-20% | 20-40% | 20-40% | 20-40% |
| H21 | 1-19% | 1-19% | 20-38% | 20-38% | 40-58% |
| H22 | 1-20% | 1-20% | 20-40% | 40-60% | 1-20% |
| H23 | 1-19% | 1-19% | 20-38% | 40-58% | 20-38% |
| H24 | 1-18% | 1-18% | 20-37% | 60-77% | 1-18% |
| H25 | 1-20% | 1-20% | 40-60% | 1-20% | 1-20% |
| H26 | 1-20% | 1-20% | 40-60% | 1-20% | 20-40% |
| H27 | 1-18% | 1-18% | 40-57% | 1-18% | 40-57% |
| H28 | 1-20% | 1-20% | 40-60% | 20-40% | 1-20% |
| H29 | 1-19% | 1-19% | 40-58% | 20-38% | 20-38% |
| H30 | 1-18% | 1-18% | 40-57% | 40-57% | 1-18% |
| H31 | 1-20% | 1-20% | 60-80% | 1-20% | 1-20% |
| H32 | 1-18% | 1-18% | 60-77% | 1-18% | 20-37% |
| H33 | 1-18% | 1-18% | 60-77% | 20-37% | 1-18% |
| H34 | 1-17% | 1-17% | 80-96% | 1-17% | 1-17% |
| H35 | 1-20% | 20-40% | 1-20% | 1-20% | 1-20% |
| H36 | 1-20% | 20-40% | 1-20% | 1-20% | 20-40% |
| H37 | 1-20% | 20-40% | 1-20% | 1-20% | 40-60% |
| H38 | 1-18% | 20-37% | 1-18% | 1-18% | 60-77% |
| H39 | 1-20% | 20-40% | 1-20% | 20-40% | 1-20% |
| H40 | 1-20% | 20-40% | 1-20% | 20-40% | 20-40% |
| H41 | 1-19% | 20-38% | 1-19% | 20-38% | 40-58% |
| H42 | 1-20% | 20-40% | 1-20% | 40-60% | 1-20% |
| H43 | 1-19% | 20-38% | 1-19% | 40-58% | 20-38% |
| H44 | 1-18% | 20-37% | 1-18% | 60-77% | 1-18% |
| H45 | 1-20% | 20-40% | 20-40% | 1-20% | 1-20% |
| H46 | 1-20% | 20-40% | 20-40% | 1-20% | 20-40% |
| H47 | 1-19% | 20-38% | 20-38% | 1-19% | 40-58% |
| H48 | 1-20% | 20-40% | 20-40% | 20-40% | 1-20% |
| H49 | 1-20% | 20-39% | 20-39% | 20-39% | 20-39% |
| H50 | 1-19% | 20-38% | 20-38% | 40-58% | 1-19% |
| H51 | 1-20% | 20-40% | 40-60% | 1-20% | 1-20% |
| H52 | 1-19% | 20-38% | 40-58% | 1-19% | 20-38% |
| H53 | 1-19% | 20-38% | 40-58% | 20-38% | 1-19% |
| H54 | 1-18% | 20-37% | 60-77% | 1-18% | 1-18% |
| H55 | 1-20% | 40-60% | 1-20% | 1-20% | 1-20% |
| H56 | 1-20% | 40-60% | 1-20% | 1-20% | 20-40% |
| H57 | 1-18% | 40-57% | 1-18% | 1-18% | 40-57% |
| H58 | 1-20% | 40-60% | 1-20% | 20-40% | 1-20% |
| H59 | 1-19% | 40-58% | 1-19% | 20-38% | 20-38% |
| H60 | 1-18% | 40-57% | 1-18% | 40-57% | 1-18% |
| H61 | 1-20% | 40-60% | 20-40% | 1-20% | 1-20% |
| H62 | 1-19% | 40-58% | 20-38% | 1-19% | 20-38% |
| H63 | 1-19% | 40-58% | 20-38% | 20-38% | 1-19% |
| H64 | 1-18% | 40-57% | 40-57% | 1-18% | 1-18% |
| H65 | 1-20% | 60-80% | 1-20% | 1-20% | 1-20% |
| H66 | 1-18% | 60-77% | 1-18% | 1-18% | 20-37% |
| H67 | 1-18% | 60-77% | 1-18% | 20-37% | 1-18% |
| H68 | 1-18% | 60-77% | 20-37% | 1-18% | 1-18% |
| H69 | 1-17% | 80-96% | 1-17% | 1-17% | 1-17% |
| H70 | 20-40% | 1-20% | 1-20% | 1-20% | 1-20% |
| H71 | 20-40% | 1-20% | 1-20% | 1-20% | 20-40% |
| H72 | 20-40% | 1-20% | 1-20% | 1-20% | 40-60% |
| H73 | 20-37% | 1-18% | 1-18% | 1-18% | 60-77% |
| H74 | 20-40% | 1-20% | 1-20% | 20-40% | 1-20% |
| H75 | 20-40% | 1-20% | 1-20% | 20-40% | 20-40% |
| H76 | 20-38% | 1-19% | 1-19% | 20-38% | 40-58% |
| H77 | 20-40% | 1-20% | 1-20% | 40-60% | 1-20% |
| H78 | 20-38% | 1-19% | 1-19% | 40-58% | 20-38% |
| H79 | 20-37% | 1-18% | 1-18% | 60-77% | 1-18% |
| H80 | 20-40% | 1-20% | 20-40% | 1-20% | 1-20% |
| H81 | 20-40% | 1-20% | 20-40% | 1-20% | 20-40% |
| H82 | 20-38% | 1-19% | 20-38% | 1-19% | 40-58% |
| H83 | 20-40% | 1-20% | 20-40% | 20-40% | 1-20% |
| H84 | 20-39% | 1-20% | 20-39% | 20-39% | 20-39% |
| H85 | 20-38% | 1-19% | 20-38% | 40-58% | 1-19% |
| H86 | 20-40% | 1-20% | 40-60% | 1-20% | 1-20% |
| H87 | 20-38% | 1-19% | 40-58% | 1-19% | 20-38% |
| H88 | 20-38% | 1-19% | 40-58% | 20-38% | 1-19% |
| H89 | 20-37% | 1-18% | 60-77% | 1-18% | 1-18% |
| H90 | 20-40% | 20-40% | 1-20% | 1-20% | 1-20% |
| H91 | 20-40% | 20-40% | 1-20% | 1-20% | 20-40% |
| H92 | 20-38% | 20-38% | 1-19% | 1-19% | 40-58% |
| H93 | 20-40% | 20-40% | 1-20% | 20-40% | 1-20% |
| H94 | 20-39% | 20-39% | 1-20% | 20-39% | 20-39% |
| H95 | 20-38% | 20-38% | 1-19% | 40-58% | 1-19% |
| H96 | 20-40% | 20-40% | 20-40% | 1-20% | 1-20% |
| H97 | 20-39% | 20-39% | 20-39% | 1-20% | 20-39% |
| H98 | 20-39% | 20-39% | 20-39% | 20-39% | 1-20% |
| H99 | 20-38% | 20-38% | 40-58% | 1-19% | 1-19% |
| H100 | 20-40% | 40-60% | 1-20% | 1-20% | 1-20% |
| H101 | 20-38% | 40-58% | 1-19% | 1-19% | 20-38% |
| H102 | 20-38% | 40-58% | 1-19% | 20-38% | 1-19% |
| H103 | 20-38% | 40-58% | 20-38% | 1-19% | 1-19% |
| H104 | 20-37% | 60-77% | 1-18% | 1-18% | 1-18% |
| H105 | 40-60% | 1-20% | 1-20% | 1-20% | 1-20% |
| H106 | 40-60% | 1-20% | 1-20% | 1-20% | 20-40% |
| H107 | 40-57% | 1-18% | 1-18% | 1-18% | 40-57% |
| H108 | 40-60% | 1-20% | 1-20% | 20-40% | 1-20% |
| H109 | 40-58% | 1-19% | 1-19% | 20-38% | 20-38% |
| H110 | 40-57% | 1-18% | 1-18% | 40-57% | 1-18% |
| H111 | 40-60% | 1-20% | 20-40% | 1-20% | 1-20% |
| H112 | 40-58% | 1-19% | 20-38% | 1-19% | 20-38% |
| H113 | 40-58% | 1-19% | 20-38% | 20-38% | 1-19% |
| H114 | 40-57% | 1-18% | 40-57% | 1-18% | 1-18% |
| H115 | 40-60% | 20-40% | 1-20% | 1-20% | 1-20% |
| H116 | 40-58% | 20-38% | 1-19% | 1-19% | 20-38% |
| H117 | 40-58% | 20-38% | 1-19% | 20-38% | 1-19% |
| H118 | 40-58% | 20-38% | 20-38% | 1-19% | 1-19% |
| H119 | 40-57% | 40-57% | 1-18% | 1-18% | 1-18% |
| H120 | 60-80% | 1-20% | 1-20% | 1-20% | 1-20% |
| H121 | 60-77% | 1-18% | 1-18% | 1-18% | 20-37% |
| H122 | 60-77% | 1-18% | 1-18% | 20-37% | 1-18% |
| H123 | 60-77% | 1-18% | 20-37% | 1-18% | 1-18% |
| H124 | 60-77% | 20-37% | 1-18% | 1-18% | 1-18% |
| H125 | 80-96% | 1-17% | 1-17% | 1-17% | 1-17% |

In some embodiments, CO₂ represents at least 15% by weight, or at least 20% by weight, or at least 25% by weight, or at least 30% by weight, or at least 35% by weight, or at least 40% by weight, of the heat transfer fluid; or CO₂ and HFC-134a together represent at least 15% by weight, or at least 20% by weight, or at least 25% by weight, or at least 30% by weight, or at least 35% by weight, or at least 40% by weight, of the heat transfer fluid; or CO₂ and HFC-125 together represent at least 15% by weight, or at least 20% by weight, or at least 25% by weight, or at least 30% by weight, or at least 35% by weight, or at least 40% by weight, of the heat transfer fluid; or CO₂, HFC-125 and HFC-134a together represent at least 15% by weight, or at least 20% by weight, or at least 25% by weight, or at least 30% by weight, or at least 35% by weight, or at least 40% by weight, of the heat transfer fluid. Given that CO₂, HFC-125 and HFC-134a are non-flammable compounds, these embodiments are preferred so that the heat transfer fluid is itself non-flammable.

The “non-flammable” nature of a fluid is assessed within the meaning of standard ASHRAE 34-2007, with a test temperature of 60° C. instead of 100° C.

In some embodiments, the heat transfer fluid has a GWP of less than or equal to 1100; or less than or equal to 1000; or less than or equal to 900; or less than or equal to 800; or less than or equal to 700; or less than or equal to 600; or less than or equal to 500; or less than or equal to 400; or less than or equal to 300; or less than or equal to 200; or less than or equal to 150; or less than or equal to 100; or less than or equal to 50.

In order to allow for optimal replacement of R-410A, it is desirable for the heat transfer fluid of the invention to meet several of the following criteria (and preferably all):
the volumetric capacity obtained with the heat transfer fluid is approximately equal to or greater than that of R-410A, in particular is at least 90%, or at least 95%, or at least 100% of that of R-410A;
the coefficient of performance obtained with the heat transfer fluid is approximately equal to or greater than that of R-410A, in particular is at least 90%, or at least 95%, or at least 100% of that of R-410A;
the heat transfer fluid is non-flammable;
the heat transfer fluid has a low GWP;
the pressure at the compressor outlet obtained with the heat transfer fluid is not too high compared to that obtained with R-410A, and in particular is less than or equal to 1.7 times that obtained with R-410A, or is less than or equal to 1.6 times that obtained with R-410A, or is less than or equal to 1.5 times that obtained with R-410A, or is less than or equal to 1.4 times that obtained with R-410A, or is less than or equal to 1.3 times that obtained with R-410A, or is less than or equal to 1.2 times that obtained with R-410A, or is less than or equal to 1.1 times that obtained with R-410A;
the temperature glide at the evaporator obtained with the heat transfer fluid is moderate, and in particular is less than or equal to 10° C., or less than or equal to 8° C., or less than or equal to 6° C., or less than or equal to 5° C., or less than or equal to 4° C., or less than or equal to 3° C., or less than or equal to 2° C., or less than or equal to 1° C.

Compositions consisting essentially (or consisting) of the following compounds provide, for example, a good set of properties, especially for the replacement of R-410A in moderate-temperature cooling or moderate-temperature heating processes:
from 40 to 70% of HFO-1123, from 5 to 30% of CO₂ and from 5 to 30% of HFC-125 (by weight);
from 55 to 70% of HFO-1123, from 5 to 30% of CO₂ and from 5 to 35% of HFC-134a (by weight);
from 5 to 70% of HFO-1123, from 5 to 35% of CO₂ and from 5 to 60% of HFC-32 (by weight);
from 5 to 55% of HFO-1123, from 5 to 35% of CO₂, from 5 to 25% of HFC-125 and from 5 to 60% of HFC-32 (by weight);
from 5 to 65% of HFO-1123, from 5 to 30% of CO₂, from 5 to 30% of HFC-125, from 5 to 10% of HFC-134a and from 5 to 65% of HFC-32 (by weight).

### EXAMPLES

The examples that follow illustrate the invention without limiting it.

### Example 1—Method of Calculating the Properties of the Heat Transfer Fluids in the Various Configurations Envisioned

The RK-Soave equation is used for the calculation of densities, enthalpies, entropies and liquid vapor equilibrium data of the mixtures. The use of this equation requires knowledge of the properties of the pure substances used in the mixtures in question and also the coefficients of interaction for each binary.

The data available for each pure substance are: the boiling point, the critical temperature and the critical pressure, the curve of pressure as a function of temperature starting from the boiling point to the critical point, the densities of saturated liquid and saturated steam as a function of temperature.

Data on hydrofluorocarbons are published in the ASHRAE Handbook 2005 chapter 20 and are also available under Refrop (software developed by NIST for the calculation of the properties of refrigerants).

The data of the temperature-pressure curve for the hydrofluoroolefins are measured by the static method. The critical temperature and the critical pressure are measured using a C80 calorimeter sold by Setaram.

The RK-Soave equation uses coefficients of binary interaction to represent the behavior of products as a mixture. The coefficients are calculated according to the experimental liquid vapor equilibrium data.

The technique used for liquid vapor equilibrium measurements is the analytical static cell method. The equilibrium cell comprises a sapphire tube and is equipped with two ROLSI™ electromagnetic samplers. It is immersed in a cryothermostat bath (Huber HS40). A rotating magnetic field stirrer rotating at variable speed is used to accelerate reaching of equilibria. Analysis of the samples is carried out by gas chromatography (HP5890 series II) using a katharometer (TCD).

Liquid-vapor equilibrium measurements were performed on the following binary mixtures: HFO-1123/CO₂; HFO-1123/HFC-32; HFO-1123/HFC-125; HFO-1123/HFC-134a.

### Example 2—Refrigeration Performance Levels

In the following, the data of example 1 are used to simulate the behavior of mixtures according to the invention in an air conditioning process.

The system considered is a compression system equipped with an evaporator and countercurrent condenser, a compressor and an expansion valve.

The system operates with 5° C. superheating and 5° C. subcooling.

The coefficient of performance (COP) is defined as being the useful power supplied by the system over the power supplied or consumed by the system.

The system operates with an inlet temperature of the refrigerant in the evaporator of 5° C. and a temperature at the start of condensation of the refrigerant in the condenser of 35° C.

The performance levels of the compositions are given in the tables below.

In these tables, “Tₛᵥ evap.” denotes the saturated vapor temperature in the evaporator, “Tₒᵤₜ comp.” denotes the temperature at the compressor outlet, “Tₛₗ cond.” denotes the saturated liquid temperature in the condenser, “Tₛᵥ cond.” denotes the saturated vapor temperature in the condenser, “Pₘᵢₙ” denotes the pressure in the evaporator, “Pₘₐₓ” denotes the pressure in the condenser, “Ratio” denotes the compression ratio (namely the ratio of the two pressures above), “ΔT evap.” denotes the temperature glide in the evaporator, “% CAP” denotes the volumetric capacity related (in %) to the reference fluid R-410A, and “% COP” denotes the coefficient of performance related (in %) to the reference fluid R-410A.

TABLE 1
HFO-1123/CO₂/HFC-125 ternary mixtures

| | | | | Tₛᵥ evap. | Tₒᵤₜ comp. | Tₛₗ cond. | Tₛᵥ cond. | Pₘᵢₙ | Pₘₐₓ | | ΔT evap. | | |
|---|---|---|---|---|---|---|---|---|---|---|---|---|---|
| GWP | R-410A | | | (° C.) | (° C.) | (° C.) | (° C.) | (bar) | (bar) | Ratio | (° C.) | % CAP | % COP |
| 2100 | R1123 (%) | CO₂ (%) | R125 (%) | 5.1 | 67.7 | 34.9 | 35.0 | 9.3 | 21.4 | 2.3 | 0.1 | 100.0 | 100.0 |
| 701 | 70 | 10 | 20 | 8.6 | 56.8 | 31.4 | 35.0 | 14.8 | 29.0 | 2.0 | 3.6 | 133.7 | 106.5 |
| 526 | 70 | 15 | 15 | 9.5 | 57.5 | 30.5 | 35.0 | 16.4 | 31.2 | 1.9 | 4.5 | 147.1 | 111.2 |
| 701 | 65 | 15 | 20 | 9.9 | 57.4 | 30.2 | 35.0 | 16.4 | 31.0 | 1.9 | 4.9 | 147.6 | 111.6 |
| 351 | 70 | 20 | 10 | 10.2 | 58.4 | 29.8 | 35.0 | 18.0 | 33.4 | 1.9 | 5.2 | 159.6 | 113.3 |
| 526 | 65 | 20 | 15 | 10.6 | 58.1 | 29.5 | 35.0 | 18.0 | 33.2 | 1.8 | 5.6 | 160.4 | 115.3 |
| 701 | 60 | 20 | 20 | 10.9 | 58.1 | 29.2 | 35.0 | 18.0 | 33.0 | 1.8 | 5.9 | 161.3 | 115.9 |

TABLE 2
HFO-1123/CO₂/HFC-134a ternary mixtures

| | | | | Tₛᵥ evap. | Tₒᵤₜ comp. | Tₛₗ cond. | Tₛᵥ cond. | Pₘᵢₙ | Pₘₐₓ | | ΔT evap. | | |
|---|---|---|---|---|---|---|---|---|---|---|---|---|---|
| GWP | R-410A | | | (° C.) | (° C.) | (° C.) | (° C.) | (bar) | (bar) | Ratio | (° C.) | % CAP | % COP |
| 2100 | R1123 (%) | CO₂ (%) | R134a (%) | 5.1 | 67.7 | 34.9 | 35.0 | 9.3 | 21.4 | 2.3 | 0.1 | 100.0 | 100.0 |
| 358 | 70 | 5 | 25 | 11.2 | 56.3 | 29.9 | 35.0 | 12.3 | 23.7 | 1.9 | 6.2 | 123.1 | 121.2 |
| 430 | 65 | 5 | 30 | 12.7 | 55.7 | 28.5 | 35.0 | 12.0 | 22.5 | 1.9 | 7.7 | 124.2 | 131.0 |
| 287 | 70 | 10 | 20 | 11.5 | 57.1 | 29.4 | 35.0 | 14.0 | 26.4 | 1.9 | 6.5 | 136.2 | 121.8 |
| 358 | 65 | 10 | 25 | 13.0 | 56.4 | 28.0 | 35.0 | 13.8 | 25.2 | 1.8 | 8.0 | 138.0 | 132.0 |
| 215 | 70 | 15 | 15 | 11.5 | 57.9 | 29.1 | 35.0 | 15.8 | 29.2 | 1.8 | 6.5 | 148.6 | 121.2 |
| 287 | 65 | 15 | 20 | 13.0 | 57.4 | 27.9 | 35.0 | 15.5 | 28.0 | 1.8 | 8.0 | 150.7 | 130.3 |
| 144 | 70 | 20 | 10 | 11.4 | 58.8 | 29.0 | 35.0 | 17.5 | 32.0 | 1.8 | 6.4 | 160.3 | 119.2 |
| 215 | 65 | 20 | 15 | 12.7 | 58.3 | 27.9 | 35.0 | 17.3 | 30.9 | 1.8 | 7.7 | 162.4 | 127.4 |
| 72 | 70 | 25 | 5 | 11.2 | 59.5 | 28.9 | 35.0 | 19.3 | 34.9 | 1.8 | 6.2 | 171.3 | 117.9 |
| 144 | 65 | 25 | 10 | 12.3 | 59.2 | 28.1 | 35.0 | 19.0 | 33.9 | 1.8 | 7.3 | 173.3 | 123.9 |

TABLE 3
HFO-1123/CO₂/HFC-32 ternary mixtures

| | | | | Tₛᵥ evap. | Tₒᵤₜ comp. | Tₛₗ cond. | Tₛᵥ cond. | Pₘᵢₙ | Pₘₐₓ | | ΔT evap. | | |
|---|---|---|---|---|---|---|---|---|---|---|---|---|---|
| GWP | R-410A | | | (° C.) | (° C.) | (° C.) | (° C.) | (bar) | (bar) | Ratio | (° C.) | % CAP | % COP |
| 2100 | R32 (%) | R1123 (%) | CO₂ (%) | 5.1 | 67.7 | 34.9 | 35.0 | 9.3 | 21.4 | 2.3 | 0.1 | 100.0 | 100.0 |
| 271 | 40 | 30 | 30 | 12.2 | 69.6 | 28.4 | 35.0 | 19.0 | 34.8 | 1.8 | 7.2 | 187.1 | 124.6 |
| 304 | 45 | 25 | 30 | 12.7 | 70.1 | 27.9 | 35.0 | 18.8 | 34.0 | 1.8 | 7.7 | 187.9 | 128.5 |

TABLE 4
HFO-1123/CO₂/HFC-32/HFC-125 quaternary mixtures

| | | | | | Tₛᵥ evap. | Tₒᵤₜ comp. | Tₛₗ cond. | Tₛᵥ cond. | Pₘᵢₙ | Pₘₐₓ | | ΔT evap. | | |
|---|---|---|---|---|---|---|---|---|---|---|---|---|---|---|
| GWP | R-410A | | | | (° C.) | (° C.) | (° C.) | (° C.) | (bar) | (bar) | Ratio | (° C.) | % CAP | % COP |
| 2100 | R32 (%) | R1123 (%) | CO₂ (%) | R125 (%) | 5.1 | 67.7 | 34.9 | 35.0 | 9.3 | 21.4 | 2.3 | 0.1 | 100.0 | 100.0 |
| 762 | 35 | 35 | 15 | 15 | 10.2 | 66.1 | 29.9 | 35.0 | 15.3 | 29.6 | 1.9 | 5.2 | 153.3 | 117.3 |
| 795 | 40 | 30 | 15 | 15 | 10.4 | 67.0 | 29.6 | 35.0 | 15.1 | 29.1 | 1.9 | 5.4 | 153.5 | 119.6 |
| 553 | 30 | 40 | 20 | 10 | 10.6 | 66.0 | 29.6 | 35.0 | 16.9 | 32.1 | 1.9 | 5.6 | 164.7 | 117.4 |
| 587 | 35 | 35 | 20 | 10 | 10.9 | 66.9 | 29.3 | 35.0 | 16.7 | 31.6 | 1.9 | 5.9 | 165.3 | 119.7 |
| 621 | 40 | 30 | 20 | 10 | 11.2 | 67.8 | 29.0 | 35.0 | 16.5 | 31.0 | 1.9 | 6.2 | 165.8 | 122.3 |
| 654 | 45 | 25 | 20 | 10 | 11.5 | 68.6 | 28.6 | 35.0 | 16.2 | 30.4 | 1.9 | 6.5 | 166.0 | 125.1 |
| 688 | 50 | 20 | 20 | 10 | 11.9 | 69.3 | 28.3 | 35.0 | 16.0 | 29.7 | 1.9 | 6.9 | 166.0 | 128.0 |
| 722 | 55 | 15 | 20 | 10 | 12.1 | 70.1 | 27.9 | 35.0 | 15.7 | 29.1 | 1.9 | 7.1 | 165.6 | 130.7 |
| 755 | 60 | 10 | 20 | 10 | 12.3 | 70.8 | 27.6 | 35.0 | 15.4 | 28.5 | 1.8 | 7.3 | 164.9 | 133.1 |
| 789 | 65 | 5 | 20 | 10 | 12.5 | 71.6 | 27.4 | 35.0 | 15.1 | 27.9 | 1.8 | 7.5 | 163.9 | 135.2 |
| 728 | 30 | 35 | 20 | 15 | 11.1 | 65.4 | 29.1 | 35.0 | 16.9 | 31.7 | 1.9 | 6.1 | 165.5 | 120.2 |
| 762 | 35 | 30 | 20 | 15 | 11.3 | 66.3 | 28.8 | 35.0 | 16.6 | 31.2 | 1.9 | 6.3 | 166.0 | 122.6 |
| 795 | 40 | 25 | 20 | 15 | 11.6 | 67.0 | 28.5 | 35.0 | 16.4 | 30.6 | 1.9 | 6.6 | 166.3 | 125.8 |
| 344 | 25 | 45 | 25 | 5 | 10.8 | 65.9 | 29.5 | 35.0 | 18.5 | 34.7 | 1.9 | 5.8 | 174.6 | 116.0 |
| 378 | 30 | 40 | 25 | 5 | 11.1 | 67.0 | 29.3 | 35.0 | 18.3 | 34.2 | 1.9 | 6.1 | 175.4 | 118.1 |
| 412 | 35 | 35 | 25 | 5 | 11.4 | 67.8 | 29.0 | 35.0 | 18.0 | 33.6 | 1.9 | 6.4 | 176.2 | 120.9 |
| 446 | 40 | 30 | 25 | 5 | 11.8 | 68.6 | 28.6 | 35.0 | 17.8 | 32.9 | 1.9 | 6.8 | 176.9 | 123.9 |
| 479 | 45 | 25 | 25 | 5 | 12.2 | 69.3 | 28.1 | 35.0 | 17.5 | 32.2 | 1.8 | 7.2 | 177.5 | 127.4 |
| 513 | 50 | 20 | 25 | 5 | 12.6 | 69.9 | 27.7 | 35.0 | 17.3 | 31.5 | 1.8 | 7.6 | 177.8 | 131.0 |
| 547 | 55 | 15 | 25 | 5 | 13.0 | 70.5 | 27.3 | 35.0 | 17.0 | 30.7 | 1.8 | 8.0 | 177.8 | 134.6 |
| 486 | 20 | 45 | 25 | 10 | 11.0 | 64.3 | 29.3 | 35.0 | 18.7 | 34.8 | 1.9 | 6.0 | 174.8 | 117.1 |
| 519 | 25 | 40 | 25 | 10 | 11.2 | 65.4 | 29.1 | 35.0 | 18.5 | 34.3 | 1.9 | 6.2 | 175.7 | 118.7 |
| 553 | 30 | 35 | 25 | 10 | 11.5 | 66.4 | 28.8 | 35.0 | 18.2 | 33.8 | 1.9 | 6.5 | 176.5 | 121.1 |
| 587 | 35 | 30 | 25 | 10 | 11.9 | 67.2 | 28.5 | 35.0 | 18.0 | 33.1 | 1.8 | 6.9 | 177.3 | 124.2 |
| 621 | 40 | 25 | 25 | 10 | 12.3 | 67.9 | 28.1 | 35.0 | 17.7 | 32.5 | 1.8 | 7.3 | 177.9 | 127.5 |
| 654 | 45 | 20 | 25 | 10 | 12.7 | 68.6 | 27.7 | 35.0 | 17.5 | 31.8 | 1.8 | 7.7 | 178.3 | 130.9 |
| 627 | 15 | 45 | 25 | 15 | 11.3 | 62.8 | 29.0 | 35.0 | 18.9 | 34.9 | 1.8 | 6.3 | 175.2 | 117.9 |
| 661 | 20 | 40 | 25 | 15 | 11.5 | 63.8 | 28.9 | 35.0 | 18.7 | 34.5 | 1.8 | 6.5 | 176.1 | 120.2 |
| 694 | 25 | 35 | 25 | 15 | 11.7 | 65.0 | 28.7 | 35.0 | 18.4 | 34.0 | 1.8 | 6.7 | 176.8 | 121.3 |
| 728 | 30 | 30 | 25 | 15 | 12.0 | 65.8 | 28.3 | 35.0 | 18.2 | 33.4 | 1.8 | 7.0 | 177.7 | 124.2 |
| 762 | 35 | 25 | 25 | 15 | 12.4 | 66.5 | 28.0 | 35.0 | 17.9 | 32.7 | 1.8 | 7.4 | 178.4 | 127.7 |
| 795 | 40 | 20 | 25 | 15 | 12.7 | 67.3 | 27.6 | 35.0 | 17.7 | 32.0 | 1.8 | 7.7 | 178.9 | 130.8 |
| 768 | 10 | 45 | 25 | 20 | 11.7 | 61.3 | 28.7 | 35.0 | 19.1 | 34.9 | 1.8 | 6.7 | 175.7 | 119.4 |
| 446 | 40 | 25 | 30 | 5 | 12.7 | 68.8 | 27.8 | 35.0 | 19.0 | 34.4 | 1.8 | 7.7 | 188.4 | 128.0 |
| 587 | 35 | 25 | 30 | 10 | 12.7 | 67.6 | 27.8 | 35.0 | 19.3 | 34.7 | 1.8 | 7.7 | 189.0 | 127.7 |

TABLE 5
HFO-1123/CO₂/HFC-32/HFC-125/HFC-134a quinary mixtures

| | | | | | | | | | | | | | ΔT | | |
|---|---|---|---|---|---|---|---|---|---|---|---|---|---|---|---|
| | R-410A | | | | | Tₛᵥ evap. | Tₒᵤₜ comp. | Tₛₗ cond. | Tₛᵥ cond. | Pₘᵢₙ | Pₘₐₓ | | evap. | | |
| GWP | R32 | R1123 | CO₂ | R125 | R134a | (° C.) | (° C.) | (° C.) | (° C.) | (bar) | (bar) | Ratio | (° C.) | % CAP | % COP |
| 2100 | (%) | (%) | (%) | (%) | (%) | 5.1 | 67.7 | 34.9 | 35.0 | 9.3 | 21.4 | 2.3 | 0.1 | 100.0 | 100.0 |
| 702 | 5 | 65 | 5 | 15 | 10 | 8.8 | 57.4 | 31.7 | 35.0 | 12.8 | 25.6 | 2.0 | 3.8 | 122.3 | 108.9 |
| 736 | 10 | 60 | 5 | 15 | 10 | 9.0 | 58.6 | 31.5 | 35.0 | 12.7 | 25.5 | 2.0 | 4.0 | 123.8 | 110.5 |
| 561 | 10 | 60 | 10 | 10 | 10 | 10.2 | 59.4 | 30.2 | 35.0 | 14.3 | 27.6 | 1.9 | 5.2 | 137.9 | 115.8 |
| 595 | 15 | 55 | 10 | 10 | 10 | 10.4 | 60.5 | 30.0 | 35.0 | 14.2 | 27.3 | 1.9 | 5.4 | 139.2 | 117.4 |
| 629 | 20 | 50 | 10 | 10 | 10 | 10.7 | 61.6 | 29.8 | 35.0 | 14.0 | 27.0 | 1.9 | 5.7 | 140.3 | 119.4 |
| 662 | 25 | 45 | 10 | 10 | 10 | 10.9 | 62.5 | 29.5 | 35.0 | 13.9 | 26.7 | 1.9 | 5.9 | 141.1 | 121.8 |
| 696 | 30 | 40 | 10 | 10 | 10 | 11.2 | 63.5 | 29.2 | 35.0 | 13.7 | 26.2 | 1.9 | 6.2 | 141.6 | 123.8 |
| 730 | 35 | 35 | 10 | 10 | 10 | 11.4 | 64.5 | 28.9 | 35.0 | 13.5 | 25.8 | 1.9 | 6.4 | 141.8 | 126.0 |
| 763 | 40 | 30 | 10 | 10 | 10 | 11.5 | 65.3 | 28.7 | 35.0 | 13.3 | 25.3 | 1.9 | 6.5 | 141.6 | 128.2 |
| 797 | 45 | 25 | 10 | 10 | 10 | 11.7 | 66.3 | 28.5 | 35.0 | 13.1 | 24.9 | 1.9 | 6.7 | 141.0 | 129.6 |
| 528 | 5 | 65 | 10 | 10 | 10 | 10.0 | 58.2 | 30.4 | 35.0 | 14.3 | 27.7 | 1.9 | 5.0 | 136.4 | 114.2 |
| 561 | 10 | 60 | 10 | 10 | 10 | 10.2 | 59.4 | 30.2 | 35.0 | 14.3 | 27.6 | 1.9 | 5.2 | 137.9 | 115.8 |
| 595 | 15 | 55 | 10 | 10 | 10 | 10.4 | 60.5 | 30.0 | 35.0 | 14.2 | 27.3 | 1.9 | 5.4 | 139.2 | 117.7 |
| 629 | 20 | 50 | 10 | 10 | 10 | 10.7 | 61.5 | 29.8 | 35.0 | 14.0 | 27.0 | 1.9 | 5.7 | 140.3 | 119.7 |
| 662 | 25 | 45 | 10 | 10 | 10 | 10.9 | 62.5 | 29.5 | 35.0 | 13.9 | 26.7 | 1.9 | 5.9 | 141.1 | 121.7 |
| 696 | 30 | 40 | 10 | 10 | 10 | 11.2 | 63.5 | 29.2 | 35.0 | 13.7 | 26.2 | 1.9 | 6.2 | 141.6 | 124.0 |
| 730 | 35 | 35 | 10 | 10 | 10 | 11.4 | 64.4 | 28.9 | 35.0 | 13.5 | 25.8 | 1.9 | 6.4 | 141.8 | 126.1 |
| 763 | 40 | 30 | 10 | 10 | 10 | 11.5 | 65.3 | 28.7 | 35.0 | 13.3 | 25.3 | 1.9 | 6.5 | 141.6 | 128.1 |
| 797 | 45 | 25 | 10 | 10 | 10 | 11.7 | 66.3 | 28.5 | 35.0 | 13.1 | 24.9 | 1.9 | 6.7 | 141.0 | 129.7 |
| 631 | 5 | 65 | 10 | 15 | 5 | 9.3 | 58.1 | 31.0 | 35.0 | 14.5 | 28.4 | 2.0 | 4.3 | 135.8 | 110.5 |
| 665 | 10 | 60 | 10 | 15 | 5 | 9.4 | 59.4 | 30.8 | 35.0 | 14.5 | 28.3 | 2.0 | 4.4 | 137.2 | 111.4 |
| 698 | 15 | 55 | 10 | 15 | 5 | 9.5 | 60.6 | 30.7 | 35.0 | 14.4 | 28.1 | 2.0 | 4.5 | 138.4 | 112.8 |
| 732 | 20 | 50 | 10 | 15 | 5 | 9.7 | 61.7 | 30.6 | 35.0 | 14.2 | 27.9 | 2.0 | 4.7 | 139.4 | 114.3 |
| 766 | 25 | 45 | 10 | 15 | 5 | 9.9 | 62.9 | 30.4 | 35.0 | 14.1 | 27.6 | 2.0 | 4.9 | 140.2 | 115.7 |
| 800 | 30 | 40 | 10 | 15 | 5 | 10.1 | 63.9 | 30.1 | 35.0 | 13.9 | 27.2 | 2.0 | 5.1 | 140.7 | 117.5 |
| 702 | 5 | 60 | 10 | 15 | 10 | 10.5 | 57.8 | 30.0 | 35.0 | 14.2 | 27.3 | 1.9 | 5.5 | 136.7 | 117.0 |
| 736 | 10 | 55 | 10 | 15 | 10 | 10.7 | 58.9 | 29.8 | 35.0 | 14.1 | 27.1 | 1.9 | 5.7 | 138.2 | 118.5 |
| 770 | 15 | 50 | 10 | 15 | 10 | 10.9 | 59.9 | 29.6 | 35.0 | 14.0 | 26.9 | 1.9 | 5.9 | 139.4 | 121.1 |
| 702 | 5 | 60 | 10 | 15 | 10 | 10.5 | 57.8 | 30.0 | 35.0 | 14.2 | 27.3 | 1.9 | 5.5 | 136.7 | 117.0 |
| 353 | 5 | 65 | 15 | 5 | 10 | 10.9 | 59.0 | 29.5 | 35.0 | 15.9 | 29.8 | 1.9 | 5.9 | 149.5 | 118.1 |
| 386 | 10 | 60 | 15 | 5 | 10 | 11.1 | 60.2 | 29.4 | 35.0 | 15.8 | 29.6 | 1.9 | 6.1 | 150.9 | 119.2 |
| 420 | 15 | 55 | 15 | 5 | 10 | 11.3 | 61.3 | 29.2 | 35.0 | 15.7 | 29.3 | 1.9 | 6.3 | 152.3 | 121.4 |
| 454 | 20 | 50 | 15 | 5 | 10 | 11.6 | 62.3 | 28.9 | 35.0 | 15.5 | 29.0 | 1.9 | 6.6 | 153.5 | 123.6 |
| 487 | 25 | 45 | 15 | 5 | 10 | 11.9 | 63.2 | 28.6 | 35.0 | 15.3 | 28.6 | 1.9 | 6.9 | 154.4 | 126.0 |
| 521 | 30 | 40 | 15 | 5 | 10 | 12.3 | 64.1 | 28.2 | 35.0 | 15.1 | 28.1 | 1.9 | 7.3 | 155.2 | 129.0 |
| 555 | 35 | 35 | 15 | 5 | 10 | 12.5 | 64.8 | 27.9 | 35.0 | 15.0 | 27.6 | 1.8 | 7.5 | 155.6 | 131.9 |
| 588 | 40 | 30 | 15 | 5 | 10 | 12.8 | 65.6 | 27.5 | 35.0 | 14.7 | 27.0 | 1.8 | 7.8 | 155.7 | 134.8 |
| 456 | 5 | 65 | 15 | 10 | 5 | 10.1 | 59.0 | 30.1 | 35.0 | 16.1 | 30.5 | 1.9 | 5.1 | 148.8 | 113.9 |
| 490 | 10 | 60 | 15 | 10 | 5 | 10.2 | 60.3 | 30.0 | 35.0 | 16.0 | 30.4 | 1.9 | 5.2 | 150.2 | 114.8 |
| 523 | 15 | 55 | 15 | 10 | 5 | 10.4 | 61.4 | 29.9 | 35.0 | 15.9 | 30.2 | 1.9 | 5.4 | 151.4 | 116.1 |
| 557 | 20 | 50 | 15 | 10 | 5 | 10.6 | 62.6 | 29.7 | 35.0 | 15.7 | 29.9 | 1.9 | 5.6 | 152.4 | 117.7 |
| 591 | 25 | 45 | 15 | 10 | 5 | 10.8 | 63.7 | 29.5 | 35.0 | 15.5 | 29.5 | 1.9 | 5.8 | 153.3 | 119.5 |
| 625 | 30 | 40 | 15 | 10 | 5 | 11.1 | 64.6 | 29.2 | 35.0 | 15.3 | 29.1 | 1.9 | 6.1 | 154.0 | 121.8 |
| 658 | 35 | 35 | 15 | 10 | 5 | 11.4 | 65.6 | 28.9 | 35.0 | 15.1 | 28.6 | 1.9 | 6.4 | 154.4 | 124.1 |
| 692 | 40 | 30 | 15 | 10 | 5 | 11.6 | 66.4 | 28.6 | 35.0 | 14.9 | 28.1 | 1.9 | 6.6 | 154.6 | 126.7 |
| 726 | 45 | 25 | 15 | 10 | 5 | 11.9 | 67.2 | 28.3 | 35.0 | 14.7 | 27.5 | 1.9 | 6.9 | 154.4 | 129.0 |
| 759 | 50 | 20 | 15 | 10 | 5 | 12.0 | 68.1 | 28.0 | 35.0 | 14.4 | 27.0 | 1.9 | 7.0 | 154.0 | 131.3 |
| 793 | 55 | 15 | 15 | 10 | 5 | 12.2 | 69.0 | 27.8 | 35.0 | 14.2 | 26.4 | 1.9 | 7.2 | 153.1 | 133.1 |
| 528 | 5 | 60 | 15 | 10 | 10 | 11.4 | 58.7 | 29.1 | 35.0 | 15.8 | 29.4 | 1.9 | 6.4 | 150.4 | 120.9 |
| 561 | 10 | 55 | 15 | 10 | 10 | 11.6 | 59.8 | 28.9 | 35.0 | 15.7 | 29.2 | 1.9 | 6.6 | 151.8 | 122.5 |
| 595 | 15 | 50 | 15 | 10 | 10 | 11.9 | 60.8 | 28.7 | 35.0 | 15.6 | 28.9 | 1.9 | 6.9 | 153.1 | 124.6 |
| 629 | 20 | 45 | 15 | 10 | 10 | 12.1 | 61.7 | 28.4 | 35.0 | 15.4 | 28.5 | 1.9 | 7.1 | 154.2 | 127.1 |
| 662 | 25 | 40 | 15 | 10 | 10 | 12.4 | 62.6 | 28.1 | 35.0 | 15.2 | 28.1 | 1.8 | 7.4 | 155.0 | 129.7 |
| 696 | 30 | 35 | 15 | 10 | 10 | 12.7 | 63.4 | 27.7 | 35.0 | 15.0 | 27.6 | 1.8 | 7.7 | 155.5 | 132.5 |
| 730 | 35 | 30 | 15 | 10 | 10 | 13.0 | 64.2 | 27.4 | 35.0 | 14.8 | 27.1 | 1.8 | 8.0 | 155.8 | 135.4 |
| 631 | 5 | 60 | 15 | 15 | 5 | 10.6 | 58.7 | 29.7 | 35.0 | 16.0 | 30.2 | 1.9 | 5.6 | 149.6 | 116.4 |
| 665 | 10 | 55 | 15 | 15 | 5 | 10.7 | 59.9 | 29.6 | 35.0 | 15.9 | 30.1 | 1.9 | 5.7 | 150.9 | 117.3 |
| 698 | 15 | 50 | 15 | 15 | 5 | 10.8 | 61.0 | 29.5 | 35.0 | 15.8 | 29.8 | 1.9 | 5.8 | 152.0 | 118.7 |
| 732 | 20 | 45 | 15 | 15 | 5 | 11.0 | 62.1 | 29.3 | 35.0 | 15.6 | 29.5 | 1.9 | 6.0 | 153.0 | 120.5 |
| 766 | 25 | 40 | 15 | 15 | 5 | 11.3 | 63.1 | 29.0 | 35.0 | 15.4 | 29.1 | 1.9 | 6.3 | 153.8 | 122.5 |
| 800 | 30 | 35 | 15 | 15 | 5 | 11.5 | 64.1 | 28.8 | 35.0 | 15.2 | 28.6 | 1.9 | 6.5 | 154.3 | 124.7 |
| 702 | 5 | 55 | 15 | 15 | 10 | 11.9 | 58.2 | 28.6 | 35.0 | 15.7 | 29.0 | 1.8 | 6.9 | 151.3 | 124.3 |
| 736 | 10 | 50 | 15 | 15 | 10 | 12.1 | 59.2 | 28.4 | 35.0 | 15.6 | 28.8 | 1.8 | 7.1 | 152.7 | 126.4 |
| 770 | 15 | 45 | 15 | 15 | 10 | 12.4 | 60.3 | 28.2 | 35.0 | 15.5 | 28.4 | 1.8 | 7.4 | 153.9 | 128.3 |
| 281 | 5 | 65 | 20 | 5 | 5 | 10.8 | 59.9 | 29.5 | 35.0 | 17.6 | 32.7 | 1.9 | 5.8 | 161.0 | 116.4 |
| 315 | 10 | 60 | 20 | 5 | 5 | 10.8 | 61.2 | 29.5 | 35.0 | 17.5 | 32.6 | 1.9 | 5.8 | 162.1 | 116.8 |
| 349 | 15 | 55 | 20 | 5 | 5 | 11.0 | 62.4 | 29.4 | 35.0 | 17.3 | 32.3 | 1.9 | 6.0 | 163.1 | 117.9 |
| 382 | 20 | 50 | 20 | 5 | 5 | 11.2 | 63.5 | 29.2 | 35.0 | 17.1 | 32.0 | 1.9 | 6.2 | 164.2 | 119.6 |
| 416 | 25 | 45 | 20 | 5 | 5 | 11.5 | 64.5 | 29.0 | 35.0 | 16.9 | 31.5 | 1.9 | 6.5 | 165.1 | 121.7 |
| 450 | 30 | 40 | 20 | 5 | 5 | 11.8 | 65.4 | 28.7 | 35.0 | 16.7 | 31.0 | 1.9 | 6.8 | 166.0 | 124.3 |
| 483 | 35 | 35 | 20 | 5 | 5 | 12.1 | 66.2 | 28.3 | 35.0 | 16.5 | 30.5 | 1.8 | 7.1 | 166.7 | 127.2 |
| 517 | 40 | 30 | 20 | 5 | 5 | 12.5 | 67.0 | 27.9 | 35.0 | 16.3 | 29.9 | 1.8 | 7.5 | 167.2 | 130.5 |
| 551 | 45 | 25 | 20 | 5 | 5 | 12.8 | 67.7 | 27.5 | 35.0 | 16.0 | 29.2 | 1.8 | 7.8 | 167.3 | 133.7 |
| 353 | 5 | 60 | 20 | 5 | 10 | 12.0 | 59.5 | 28.5 | 35.0 | 17.4 | 31.6 | 1.8 | 7.0 | 162.9 | 123.4 |
| 386 | 10 | 55 | 20 | 5 | 10 | 12.2 | 60.7 | 28.4 | 35.0 | 17.2 | 31.3 | 1.8 | 7.2 | 164.2 | 124.7 |
| 420 | 15 | 50 | 20 | 5 | 10 | 12.5 | 61.6 | 28.1 | 35.0 | 17.0 | 31.0 | 1.8 | 7.5 | 165.4 | 127.1 |
| 454 | 20 | 45 | 20 | 5 | 10 | 12.8 | 62.5 | 27.8 | 35.0 | 16.9 | 30.5 | 1.8 | 7.8 | 166.6 | 129.8 |
| 456 | 5 | 60 | 20 | 10 | 5 | 11.2 | 59.4 | 29.1 | 35.0 | 17.6 | 32.4 | 1.8 | 6.2 | 162.0 | 119.4 |
| 490 | 10 | 55 | 20 | 10 | 5 | 11.3 | 60.9 | 29.1 | 35.0 | 17.4 | 32.2 | 1.8 | 6.3 | 163.1 | 119.1 |
| 523 | 15 | 50 | 20 | 10 | 5 | 11.5 | 61.9 | 28.9 | 35.0 | 17.3 | 32.0 | 1.9 | 6.5 | 164.2 | 120.7 |
| 557 | 20 | 45 | 20 | 10 | 5 | 11.7 | 63.0 | 28.7 | 35.0 | 17.1 | 31.6 | 1.9 | 6.7 | 165.2 | 122.6 |
| 591 | 25 | 40 | 20 | 10 | 5 | 12.0 | 64.0 | 28.5 | 35.0 | 16.9 | 31.1 | 1.8 | 7.0 | 166.1 | 124.9 |
| 625 | 30 | 35 | 20 | 10 | 5 | 12.3 | 64.8 | 28.1 | 35.0 | 16.6 | 30.6 | 1.8 | 7.3 | 166.9 | 127.8 |
| 658 | 35 | 30 | 20 | 10 | 5 | 12.6 | 65.6 | 27.8 | 35.0 | 16.4 | 30.0 | 1.8 | 7.6 | 167.4 | 130.8 |
| 692 | 40 | 25 | 20 | 10 | 5 | 12.9 | 66.3 | 27.4 | 35.0 | 16.2 | 29.4 | 1.8 | 7.9 | 167.7 | 134.0 |
| 528 | 5 | 55 | 20 | 10 | 10 | 12.6 | 59.1 | 28.0 | 35.0 | 17.3 | 31.2 | 1.8 | 7.6 | 164.3 | 126.9 |
| 561 | 10 | 50 | 20 | 10 | 10 | 12.8 | 60.1 | 27.8 | 35.0 | 17.2 | 30.9 | 1.8 | 7.8 | 165.5 | 128.8 |
| 631 | 5 | 55 | 20 | 15 | 5 | 11.7 | 59.2 | 28.7 | 35.0 | 17.6 | 32.1 | 1.8 | 6.7 | 163.2 | 121.3 |
| 665 | 10 | 50 | 20 | 15 | 5 | 11.8 | 60.4 | 28.6 | 35.0 | 17.4 | 31.9 | 1.8 | 6.8 | 164.3 | 122.2 |
| 698 | 15 | 45 | 20 | 15 | 5 | 12.0 | 61.5 | 28.5 | 35.0 | 17.2 | 31.6 | 1.8 | 7.0 | 165.3 | 123.8 |
| 732 | 20 | 40 | 20 | 15 | 5 | 12.2 | 62.5 | 28.2 | 35.0 | 17.0 | 31.2 | 1.8 | 7.2 | 166.3 | 126.1 |
| 766 | 25 | 35 | 20 | 15 | 5 | 12.5 | 63.4 | 28.0 | 35.0 | 16.8 | 30.7 | 1.8 | 7.5 | 167.1 | 128.5 |
| 800 | 30 | 30 | 20 | 15 | 5 | 12.8 | 64.2 | 27.6 | 35.0 | 16.6 | 30.1 | 1.8 | 7.8 | 167.7 | 131.5 |
| 281 | 5 | 60 | 25 | 5 | 5 | 11.6 | 60.5 | 28.7 | 35.0 | 19.1 | 34.6 | 1.8 | 6.6 | 173.4 | 119.7 |
| 315 | 10 | 55 | 25 | 5 | 5 | 11.7 | 61.8 | 28.7 | 35.0 | 18.9 | 34.4 | 1.8 | 6.7 | 174.3 | 120.1 |
| 349 | 15 | 50 | 25 | 5 | 5 | 11.8 | 62.9 | 28.6 | 35.0 | 18.7 | 34.1 | 1.8 | 6.8 | 175.2 | 121.4 |
| 382 | 20 | 45 | 25 | 5 | 5 | 12.1 | 64.0 | 28.4 | 35.0 | 18.5 | 33.7 | 1.8 | 7.1 | 176.2 | 123.4 |
| 416 | 25 | 40 | 25 | 5 | 5 | 12.4 | 64.9 | 28.2 | 35.0 | 18.2 | 33.2 | 1.8 | 7.4 | 177.3 | 125.9 |
| 450 | 30 | 35 | 25 | 5 | 5 | 12.8 | 65.7 | 27.8 | 35.0 | 18.0 | 32.6 | 1.8 | 7.8 | 178.2 | 129.1 |
| 353 | 5 | 55 | 25 | 5 | 10 | 13.0 | 60.0 | 27.6 | 35.0 | 18.8 | 33.4 | 1.8 | 8.0 | 176.0 | 127.9 |
| 456 | 5 | 55 | 25 | 10 | 5 | 12.1 | 60.2 | 28.3 | 35.0 | 19.1 | 34.4 | 1.8 | 7.1 | 174.8 | 122.0 |
| 490 | 10 | 50 | 25 | 10 | 5 | 12.2 | 61.4 | 28.3 | 35.0 | 18.9 | 34.1 | 1.8 | 7.2 | 175.7 | 122.9 |
| 523 | 15 | 45 | 25 | 10 | 5 | 12.4 | 62.5 | 28.2 | 35.0 | 18.7 | 33.8 | 1.8 | 7.4 | 176.7 | 124.6 |
| 557 | 20 | 40 | 25 | 10 | 5 | 12.6 | 63.5 | 28.0 | 35.0 | 18.4 | 33.3 | 1.8 | 7.6 | 177.6 | 126.8 |
| 591 | 25 | 35 | 25 | 10 | 5 | 13.0 | 64.3 | 27.6 | 35.0 | 18.2 | 32.7 | 1.8 | 8.0 | 178.7 | 129.7 |
| 631 | 5 | 50 | 25 | 15 | 5 | 12.6 | 60.0 | 27.9 | 35.0 | 19.1 | 34.1 | 1.8 | 7.6 | 176.3 | 124.2 |
| 665 | 10 | 45 | 25 | 15 | 5 | 12.7 | 60.9 | 27.9 | 35.0 | 18.9 | 33.8 | 1.8 | 7.7 | 177.3 | 126.2 |
| 698 | 15 | 40 | 25 | 15 | 5 | 12.9 | 62.0 | 27.7 | 35.0 | 18.7 | 33.4 | 1.8 | 7.9 | 178.2 | 128.0 |

1. A composition comprising 1,1,2-trifluoroethylene, carbon dioxide, 2,3,3,3-tetrafluoropropene, and difluoromethane.

2. The composition as claimed in claim 1, comprising one or more additional compounds chosen from ammonia and optionally halogenated alkanes and alkenes.

3. The composition as claimed in claim 1, comprising one or more additional compounds chosen from 1,1,1,2-tetrafluoroethane, pentafluoroethane, 1,3,3,3-tetrafluoropropene, ammonia, 1,1,1,2,3,3,3-heptafluoropropane, propane, propylene, 1,1,1-trifluoroethane, 1-chloro-3,3,3-trifluoropropene, 1,1,1,4,4,4-hexafluorobut-2-ene, 1,1,1,3,3-pentafluoropropane, 1,1,2,2-tetrafluoroethane, 1,1-difluoroethane and combinations thereof.

4. The composition as claimed in claim 1, consisting essentially of:
1,1,2-trifluoroethylene, carbon dioxide, difluoromethane and 2,3,3,3-tetrafluoropropene; or
1,1,2-trifluoroethylene, carbon dioxide, 1,1,1,2-tetrafluoroethane, difluoromethane and 2,3,3,3-tetrafluoropropene; or
1,1,2-trifluoroethylene, carbon dioxide, 1,1,1,2-tetrafluoroethane, difluoromethane, pentafluoroethane and 2,3,3,3-tetrafluoropropene; or
1,1,2-trifluoroethylene, carbon dioxide, 1,1,1,2-tetrafluoroethane, difluoromethane, pentafluoroethane, 2,3,3,3-tetrafluoropropene and 1,3,3,3-tetrafluoropropene.

5. The composition as claimed in claim 1, wherein the proportion of 1,1,2-trifluoroethylene is from 5 to 80% by weight.

6. The composition as claimed in claim 3, wherein the total proportion of carbon dioxide and where appropriate of 1,1,1,2-tetrafluoroethane and/or of pentafluoroethane is at least 15% by weight.

7. The composition as claimed in claim 1, comprising:
from 5 to 55% of 1,1,2-trifluoroethylene, from 5 to 35% of carbon dioxide, and from 5 to 60% of difluoromethane (by weight);
from 5 to 65% of 1,1,2-trifluoroethylene, from 5 to 30% of carbon dioxide, from 5 to 10% of 1,1,1,2-tetrafluoroethane and from 5 to 60% of difluoromethane (by weight).

8. The composition as claimed in claim 1, which is non-flammable.

9. The composition as claimed in claim 1, which has a GWP of less than or equal to 1000.

10. A method of replacing R-410A, comprising replacing R-410A with a heat transfer fluid comprising the composition as claimed in claim 1.

11. The method as claimed in claim 10, comprising replacing R-410A in stationary air conditioning.

12. A heat transfer composition, comprising the composition as claimed in claim 1 as a heat transfer fluid, and one or more additives.

13. The heat transfer composition as claimed in claim 12, wherein the additives are chosen from lubricants, nanoparticles, stabilizers, surfactants, tracer agents, fluorescent agents, odorants, solubilizers and combinations thereof.

14. A heat transfer apparatus comprising a vapor-compression circuit containing a composition as claimed in claim 1, as a heat transfer fluid.

15. The apparatus as claimed in claim 14, chosen from mobile or stationary apparatuses for heating by heat pump, air conditioning.

16. A process for heating or cooling a fluid or a body by means of a vapor-compression circuit containing a heat transfer fluid, said process comprising, in succession, evaporation of the heat transfer fluid, compression of the heat transfer fluid, condensation of the heat transfer fluid and expansion of the heat transfer fluid, wherein the heat transfer fluid is a composition as claimed in claim 1.

17. A process for reducing the environmental impact of a heat transfer apparatus comprising a vapor-compression circuit containing an initial heat transfer fluid, said process comprising a step of replacing the initial heat transfer fluid in the vapor-compression circuit with a final transfer fluid, the final transfer fluid having a lower GWP than the initial heat transfer fluid, wherein the final heat transfer fluid is a composition as claimed in claim 1.

18. The process as claimed in claim 17, wherein the initial heat transfer fluid is R-410A.
